(19) United States
(12) Patent Application Publication
(10) Pub. No.: US 2012/0317872 A1
(43) Pub. Date: Dec. 20, 2012

(54) PROCESS TO PRODUCE BIOFUELS FROM BIOMASS

(75) Inventors: Joseph Broun POWELL, Houston, TX (US); John Anthony SMEGAL, Houston, TX (US)

(73) Assignee: SHELL OIL COMPANY, Houston, TX (US)

(21) Appl. No.: 13/495,785

(22) Filed: Jun. 13, 2012

Related U.S. Application Data
(60) Provisional application No. 61/496,653, filed on Jun. 14, 2011.
(60) Provisional application No. 61/654,399, filed on Jun. 1, 2012.

(51) Int. Cl. C10G 1/06; B01J 8/00; C10L 1/00; B01D 5/00

(52) U.S. Cl. 44/307; 585/240; 422/187; 422/620

(57) ABSTRACT

Biofuels can be produced by: (i) providing a biomass containing celluloses, hemicelluloses, lignin, nitrogen compounds and sulfur compounds; (ii) contacting the biomass with a digestive solvent to form a pretreated biomass containing carbohydrates; (iii) contacting the pretreated biomass with hydrogen in the presence of a supported hydrogenolysis catalyst containing (a) sulfur, (b) Mo or W, and (c) Co and/or Ni incorporated into a suitable support to form a plurality of oxygenated intermediates, and (vi) processing at least a portion of the oxygenated intermediates to form a liquid fuel.

The present application claims the benefit of pending U.S. Provisional Patent Application Ser. Nos. 61/496,653, filed Jun. 14, 2011, and 61/654,399 filed Jun. 1, 2012, the entire disclosure of which is hereby incorporated by reference.

### FIELD OF THE INVENTION

The invention relates to the production of higher hydrocarbons suitable for use in transportation fuels and industrial chemicals from biomass.

### BACKGROUND OF THE INVENTION

A significant amount of attention has been placed on developing new technologies for providing energy from resources other than fossil fuels. Biomass is a resource that shows promise as a fossil fuel alternative. As opposed to fossil fuel, biomass is also renewable.

Biomass may be useful as a source of renewable fuels. One type of biomass is plant biomass. Plant biomass is the most abundant source of carbohydrate in the world due to the lignocellulosic materials composing the cell walls in higher plants. Plant cell walls are divided into two sections, primary cell walls and secondary cell walls. The primary cell wall provides structure for expanding cells and is composed of three major polysaccharides (cellulose, pectin, and hemicellulose) and one group of glycoproteins. The secondary cell wall, which is produced after the cell has finished growing, also contains polysaccharides and is strengthened through polymeric lignin covalently cross-linked to hemicellulose. Hemicellulose and pectin are typically found in abundance, but cellulose is the predominant polysaccharide and the most abundant source of carbohydrates. However, production of fuel from cellulose poses a difficult technical problem. Some of the factors for this difficulty are the physical density of lignocelluloses (like wood) that can make penetration of the biomass structure of lignocelluloses with chemicals difficult and the chemical complexity of lignocelluloses that lead to difficulty in breaking down the long chain polymeric structure of cellulose into carbohydrates that can be used to produce fuel. Another factor for this difficulty is the nitrogen compounds and sulfur compounds contained in the biomass. The nitrogen and sulfur compounds contained in the biomass can poison catalysts used in subsequent processing.

Most transportation vehicles require high power density provided by internal combustion and/or propulsion engines. These engines require clean burning fuels which are generally in liquid form or, to a lesser extent, compressed gases. Liquid fuels are more portable due to their high energy density and their ability to be pumped, which makes handling easier.

Currently, bio-based feedstocks such as biomass provide the only renewable alternative for liquid transportation fuel. Unfortunately, the progress in developing new technologies for producing liquid biofuels has been slow in developing, especially for liquid fuel products that fit within the current infrastructure. Although a variety of fuels can be produced from biomass resources, such as ethanol, methanol, and vegetable oil, and gaseous fuels, such as hydrogen and methane, these fuels require either new distribution technologies and/or combustion technologies appropriate for their characteristics. The production of some of these fuels also tends to be expensive and raise questions with respect to their net carbon savings. There is a need to directly process biomass into liquid fuels.

Processing of biomass as feeds is challenged by the need to directly couple biomass hydrolysis to release sugars, and catalytic hydrogenation/hydrogenolysis/hydrodeoxygenation of the sugar, to prevent decomposition to heavy ends (caramel, or tars).

### SUMMARY OF THE INVENTION

In an embodiment, a method comprises: (i) providing a biomass containing celluloses, hemicelluloses, lignin, nitrogen compounds and sulfur compounds; (ii) contacting the biomass with a digestive solvent to form a pretreated biomass containing carbohydrates; (iii) contacting the pretreated biomass with hydrogen in the presence of a supported hydrogenolysis catalyst containing (a) sulfur, (b) Mo or W, and (c) Co and/or Ni incorporated into a suitable support to form a plurality of oxygenated intermediates, and (vi) processing at least a portion of the oxygenated intermediates to form a liquid fuel.

In yet another embodiment, a first portion of the oxygenated intermediates are recycled to form in part the solvent in step (ii); and processing at least a second portion of the oxygenated intermediates to form a liquid fuel.

In yet another embodiment, a system comprises: a digester that receives a biomass feedstock and a digestive solvent operating under conditions effective to produce carbohydrates and discharges a treated stream comprising a carbohydrate; a hydrogenolysis reactor comprising a supported hydrogenolysis catalyst containing (a) sulfur and (b) Mo or W and (c) Co and/or Ni incorporated into a suitable support that receives hydrogen and the treated stream and discharges an oxygenated intermediate stream, wherein a first portion of the oxygenated intermediate stream is recycled to the digester as at least a portion of the digestive solvent; and a fuels processing reactor comprising a condensation catalyst that receives a second portion of the oxygenated intermediate stream and discharges a liquid fuel.

In yet another embodiment, a system comprises: a digester that receives a biomass feedstock and a digestive solvent operating under conditions effective to produce carbohydrates and discharges a treated stream comprising a carbohydrate; a hydrogenolysis reactor comprising a supported hydrogenolysis catalyst containing (a) sulfur, (b) Mo or W, and (c) Co and/or Ni incorporated into a suitable support that receives hydrogen and the treated stream and discharges an oxygenated intermediate, wherein a first portion of the oxygenated intermediate stream is recycled to the digester as at least a portion of the digestive solvent; a first fuels processing reactor comprising a dehydrogenation catalyst that receives a second portion of the oxygenated intermediate stream and discharges an olefin-containing stream; and a second fuels processing reactor comprising an alkylation or olefin oligomerization catalyst that receives the olefin-containing stream and discharges a liquid fuel.

In yet another embodiment, a composition is provided comprising: (i) lignocellulosic biomass; (ii) hydrogenolysis catalyst containing (a) sulfur, (b) Mo or W, and (c) Co, Ni or mixture thereof, and (d) phosphorus, incorporated into a suitable support; (iii) water; and (iv) digestive solvent.

The features and advantages of the invention will be apparent to those skilled in the art. While numerous changes may be made by those skilled in the art, such changes are within the spirit of the invention.

### BRIEF DESCRIPTION OF THE DRAWING

This drawing illustrates certain aspects of some of the embodiments of the invention, and should not be used to limit or define the invention.

FIG. 1 is a schematically illustrated block flow diagram of an embodiment of a higher hydrocarbon production process 100 of this invention.

### DETAILED DESCRIPTION OF THE INVENTION

The invention relates to the production of higher hydrocarbons suitable for use in transportation fuels and industrial chemicals from biomass. The higher hydrocarbons produced are useful in forming transportation fuels, such as synthetic gasoline, diesel fuel, and jet fuel, as well as industrial chemicals. As used herein, the term “higher hydrocarbons” refers to hydrocarbons having an oxygen to carbon ratio less than the oxygen to carbon ratio of at least one component of the biomass feedstock. As used herein the term “hydrocarbon” refers to an organic compound comprising primarily hydrogen and carbon atoms, which is also an unsubstituted hydrocarbon. In certain embodiments, the hydrocarbons of the invention also comprise heteroatoms (i.e., oxygen sulfur, phosphorus, or nitrogen) and thus the term “hydrocarbon” may also include substituted hydrocarbons. The term “soluble carbohydrates” refers to oligosaccharides and monosaccharides that are soluble in the digestive solvent and that can be used as feedstock to the hydrogenolysis reaction (e.g., pentoses and hexoses).

Processing of biomass as feeds is challenged by the need to directly couple biomass hydrolysis to release sugars, and catalytic hydrogenation/hydrogenolysis/hydrodeoxygenation of the sugar, to prevent decomposition to heavy ends (caramel, or tars). Nitrogen and sulfur compounds from the biomass feed can be poison the hydrogenation/hydrogenolysis/hydrodeoxygenation catalysts, such as Pt/Re catalysts, and reduce the activity of the catalysts. Biomass hydrolysis starts above 120° C. and continues through 200° C. Sulfur and nitrogen compounds can be removed by ion exchange resins (acidic) such as discussed in U.S. application 61/424,803, that are stable to 120° C., but the base resins required for complete N,S removal cannot be used above 100° C. (weak), or ° 60 C for the strong base resins. Cycling of temperature from 60° C. ion exchange to reaction temperatures on the order of 120-240° C. represents a substantial energy yield loss. Use of a poison tolerant catalyst in the process to enable direct coupling of biomass hydrolysis and hydrogenation/hydrogenolysis/hydrodeoxygenation of the resulting sugar is an advantage, for a biomass feed process. The methods and systems of the invention have an advantage of using a poison tolerant catalyst for the direct coupling of biomass hydrolysis and hydrogenation/hydrogenolysis/hydrodeoxygenation of the resulting sugar.

In some embodiments, at least a portion of oxygenated intermediates produced in the hydrogenolysis reaction are recycled within the process and system to at least in part from the in situ generated solvent, which is used in the biomass digestion process. This recycle saves costs in provision of a solvent that can be used to extract nitrogen, sulfur, and optionally phosphorus compounds from the biomass feedstock. Further, by controlling the degradation of carbohydrate in the hydrogenolysis process, hydrogenation reactions can be conducted along with the hydrogenolysis reaction at temperatures ranging from about 150° C. to 275° C. As a result, a separate hydrogenation reaction section can optionally be avoided, and the fuel forming potential of the biomass feedstock fed to the process can be increased. This process and reaction scheme described herein also results in a capital cost savings and process operational cost savings. Advantages of specific embodiments will be described in more detail below.

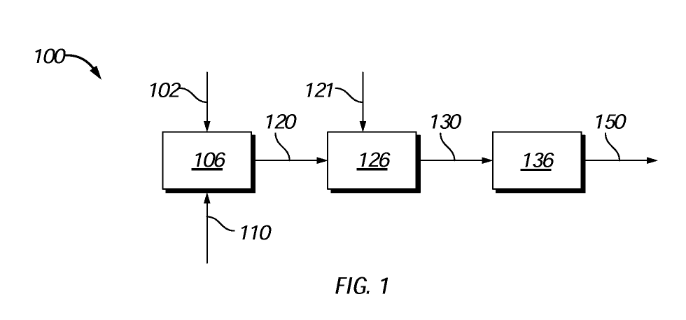

In some embodiments, the invention provides methods comprising: providing a biomass feedstock, contacting the biomass feedstock with a digestive solvent in a digestion system to form an intermediate stream comprising soluble carbohydrates, contacting the intermediate stream directly with hydrogen in the presence of a supported hydrogenolysis catalyst containing (a) sulfur and (b) Mo or W and (c) Co and/or Ni to form a plurality of oxygenated intermediates, wherein a first portion of the oxygenated intermediates are recycled to form the solvent; and contacting at least a second portion of the oxygenated intermediates with a catalyst to form a liquid fuel. In reference to FIG. 1, in one embodiment of the invention process 100, biomass 102 is provided to digestion zone 106 that may have one or more digester(s), whereby the biomass is contacted with a digestive solvent 110. The treated biomass pulp 120 contains soluble carbohydrates containing sulfur compounds and nitrogen compounds from the biomass. The sulfur and nitrogen content may vary depending on the biomass source 102. At least a portion of the treated biomass 120 is catalytically reacted with hydrogen 121, in the hydrogenolysis zone 126, in the presence of a supported hydrogenolysis catalyst containing (a) sulfur and (b) Mo or W and (c) Co and/or Ni to produce a plurality of oxygenated intermediates 130, and at least a portion of the oxygenated intermediates is processed 136 to produce higher hydrocarbons to form a liquid fuel 150.

The treated biomass 120 may be optionally washed prior to contacting in to the hydrogenolysis zone 126. If washed, water is most typically used as wash solvent.

Any suitable (e.g., inexpensive and/or readily available) type of biomass can be used. Suitable lignocellulosic biomass can be, for example, selected from, but not limited to, forestry residues, agricultural residues, herbaceous material, municipal solid wastes, waste and recycled paper, pulp and paper mill residues, and combinations thereof. Thus, in some embodiments, the biomass can comprise, for example, corn stover, straw, bagasse, miscanthus, sorghum residue, switch grass, bamboo, water hyacinth, hardwood, hardwood chips, hardwood pulp, softwood, softwood chips, softwood pulp, and/or combination of these feedstocks. The biomass can be chosen based upon a consideration such as, but not limited to, cellulose and/or hemicelluloses content, lignin content, growing time/season, growing location/transportation cost, growing costs, harvesting costs and the like.

Prior to treatment with the digestive solvent, the untreated biomass can be washed and/or reduced in size (e.g., chopping, crushing or debarking) to a convenient size and certain quality that aids in moving the biomass or mixing and impregnating the chemicals from digestive solvent. Thus, in some embodiments, providing biomass can comprise harvesting a lignocelluloses-containing plant such as, for example, a hardwood or softwood tree. The tree can be subjected to debarking, chopping to wood chips of desirable thickness, and washing to remove any residual soil, dirt and the like.

It is recognized that washing with water prior to treatment with digestive solvent is desired, to rinse and remove simple salts such as nitrate, sulfate, and phosphate salts which otherwise may be present, and contribute to measured concentrations of nitrogen, sulfur, and phosphorus compounds present. This wash is accomplished at a temperature of less than about 60 degrees Celsius, and where hydrolysis reactions comprising digestion do not occur to a significant extent. Other nitrogen, sulfur, and phosphorus compounds are bound to the biomass and are more difficult to remove, and requiring digestion and reaction of the biomass, to effect removal. These compounds may be derived from proteins, amino acids, phospholipids, and other structures within the biomass, and may be potent catalyst poisons. The poison tolerant catalyst described herein, allows some of these more difficult to remove nitrogen and sulfur compounds to be present in subsequent processing.

In the digestion zone, the size-reduced biomass is contacted with the digestive solvent where the digestion reaction takes place. The digestive solvent must be effective to digest lignins.

In one aspect of the embodiment, the digestive solvent maybe a Kraft-like digestive solvent that contains (i) at least 0.5 wt %, preferably at least 4 wt %, to at most 20 wt %, more preferably to 10 wt %, based on the digestive solvent, of at least one alkali selected from the group consisting of sodium hydroxide, sodium carbonate, sodium sulfide, potassium hydroxide, potassium carbonate, ammonium hydroxide, and mixtures thereof, (ii) optionally, 0 to 3%, based on the digestive solvent, of anthraquinone, sodium borate and/or polysulfides; and (iii) water (as remainder of the digestive solvent). In some embodiments, the digestive solvent may have an active alkali of between 5 to 25%, more preferably between 10 to 20%. The term “active alkali” (AA), as used herein, is a percentage of alkali compounds combined, expressed as sodium oxide based on weight of the biomass less water content (dry solid biomass). If sodium sulfide is present in the digestive solvent, the sulfidity can range from about 15% to about 40%, preferably from about 20 to about 30%. The term “sulfidity”, as used herein, is a percentage ratio of Na₂S, expressed as Na₂O, to active alkali. Digestive solvent to biomass ratio can be within the range of 0.5 to 50, preferably 2 to 10. The digestion is carried out typically at a cooking-liquor to biomass ratio in the range of 2 to 6, preferably 3 to 5. The digestion reaction is carried out at a temperature within the range of from about 60° C., preferably 100° C., to about 230° C., and a residence time within 0.25 h to 24 h. The reaction is carried out under conditions effective to provide a pretreated biomass stream containing pretreated biomass having a lignin content that is less than about 20% of the amount in the untreated biomass feed, and a chemical liquor stream containing alkali compounds and dissolved lignin and hemicelluloses material.

The digestion can be carried out in a suitable vessel, for example, a pressure vessel of carbon steel or stainless steel or similar alloy. The digestion zone can be carried out in the same vessel or in a separate vessel. The cooking can be done in continuous or batch mode. Suitable pressure vessels include, but are not limited to the “PANDIA™ Digester” (Voest-Alpine Industrienlagenbau GmbH, Linz, Austria), the “DEFIBRATOR Digester” (Sunds Defibrator AB Corporation, Stockholm, Sweden), M&D (Messing & Durkee) digester (Bauer Brothers Company, Springfield, Ohio, USA) and the KAMYR Digester (Andritz Inc., Glens Falls, N.Y., USA). The digestive solvent has a pH from 10 to 14, preferably around 12 to 13 depending on the concentration of active alkali AA. The contents can be kept at a temperature within the range of from 100° C. to 230° C. for a period of time, more preferably within the range from about 130° C. to about 180° C. The period of time can be from about 0.25 to 24.0 hours, preferably from about 0.5 to about 2 hours, after which the pretreated contents of the digester are discharged. For adequate penetration, a sufficient volume of liquor is required to ensure that all the biomass surfaces are wetted. Sufficient liquor is supplied to provide the specified digestive solvent to biomass ratio. The effect of greater dilution is to decrease the concentration of active chemical and thereby reduce the reaction rate.

In a system using the digestive solvent such as a Kraft-like digestive solvent similar to those used in a Kraft pulp and paper process, the chemical liquor may be regenerated in a similar manger to a Kraft pulp and paper chemical regeneration process. In another embodiment, an at least partially water miscible organic solvent that has partial solubility in water, preferably greater than 2 weight percent in water, may be used as digestive solvent to aid in digestion of lignin, and the nitrogen, and sulfur compounds. In one such embodiment, the digestive solvent is a water-organic solvent mixture with optional inorganic acid promoters such as HCl or sulfuric acid. Oxygenated solvents exhibiting full or partial water solubility are preferred digestive solvents. In such a process, the organic digestive solvent mixture can be, for example, methanol, ethanol, acetone, ethylene glycol, triethylene glycol and tetrahydrofurfuryl alcohol. Organic acids such as acetic, oxalic, acetylsalicylic and salicylic acids can also be used as catalysts (as acid promoter) in the at least partially miscible organic solvent process. Temperatures for the digestion may range from about 130 to about 220° C., preferably from about 140 to 180° C., and contact times from 0.25 to 24 hours, preferably from about one to 4 hours. Preferably, a pressure from about 25 psi to 1000 psi, and most typically from 100 to 500 psi, maintained on the system to avoid boiling or flashing away of the solvent.

Optionally the pretreated biomass stream can be washed prior to hydrogenolysis zone depending on the embodiment. In the wash system, the pretreated biomass stream can be washed to remove one or more of non-cellulosic material, and non-fibrous cellulosic material prior to hydrogenolysis. The pretreated biomass stream is optionally washed with a water stream under conditions to remove at least a portion of lignin, hemicellulosic material, and salts in the pretreated biomass stream. For example, the pretreated biomass stream can be washed with water to remove dissolved substances, including degraded, but non-processable cellulose compounds, solubilised lignin, and/or any remaining alkaline chemicals such as sodium compounds that were used for cooking or produced during the cooking (or pretreatment). The washed pretreated biomass stream may contain higher solids content by further processing such as mechanical dewatering as described below.

In a preferred embodiment, the pretreated biomass stream is washed counter-currently. The wash can be at least partially carried out within the digester and/or externally with separate washers. In one embodiment of the invention process, the wash system contains more than one wash steps, for example, first washing, second washing, third washing, etc. that produces washed pretreated biomass stream from first washing, washed pretreated biomass stream from second washing, etc. operated in a counter current flow with the water, that is then sent to subsequent processes as washed pretreated biomass stream. The water is recycled through first recycled wash stream and second recycled wash stream and then to third recycled wash stream. Water recovered from the chemical liquor stream by the concentration system can be recycled as wash water to wash system. It can be appreciated that the washed steps can be conducted with any number of steps to obtain the desired washed pretreated biomass stream. Additionally, the washing may adjust the pH for subsequent steps where the pH is about 2.0 to 10.0, where optimal pH is determined by the catalyst employed in the hydrogenolysis step. Bases such as alkali base may be optionally added, to adjust pH.

In some embodiments, the reactions described are carried out in any system of suitable design, including systems comprising continuous-flow, batch, semi-batch or multi-system vessels and reactors. One or more reactions or steps may take place in an individual vessel and the process is not limited to separate reaction vessels for each reaction or digestion. In some embodiments the system of the invention utilizes a fluidized catalytic bed system. Preferably, the invention is practiced using a continuous-flow system at steady-state equilibrium.

In one embodiment of the invention process, biomass 102 is provided to digestion system 106 that may have one or more digester(s), whereby the biomass is contacted with a digestive solvent. The digestive solvent is optionally at least a portion recycled from the hydrogenolysis reaction as a recycle stream. The hydrogenolysis recycle stream can comprise a number of components including in situ generated solvents, which may be useful as digestive solvent at least in part or in entirety. The term “in situ” as used herein refers to a component that is produced within the overall process; it is not limited to a particular reactor for production or use and is therefore synonymous with an in-process generated component. The in situ generated solvents may comprise oxygenated intermediates. The digestive process to remove nitrogen, and sulfur compounds may vary within the reaction media so that a temperature gradient exists within the reaction media, allowing for nitrogen, and sulfur compounds to be extracted at a lower temperature than cellulose. For example, the reaction sequence may comprise an increasing temperature gradient from the biomass feedstock 102. The non-extractable solids may be removed from the reaction as an outlet stream. The treated biomass stream 120 is an intermediate stream that may comprise the treated biomass at least in part in the form of carbohydrates. The composition of the treated biomass stream 120 may vary and may comprise a number of different compounds. Preferably, the contained carbohydrates will have 2 to 12 carbon atoms, and even more preferably 2 to 6 carbon atoms. The carbohydrates may also have an oxygen to carbon ratio from 0.5:1 to 1:1.2. Oligomeric carbohydrates containing more than 12 carbon atoms may also be present. At least a portion of the digested portion of the pulp from is contacted directly with hydrogen in the presence of the supported hydrogenolysis catalyst containing (a) sulfur and (b) molybdenum and/or tungsten and (c) cobalt and/or nickel to produce a plurality of oxygenated intermediates. A first portion of the oxygenated intermediate stream is recycled to digester 106. A second portion of the oxygenated intermediates is processed to produce higher hydrocarbons to form a liquid fuel.

Use of separate processing zones for steps (ii) and (iii) allows conditions to be optimized for digestion and hydrogenation or hydrogenolysis of the digested biomass components, independent from optimization of the conversion of oxygenated intermediates to monooxygenates, before feeding to step (iv) to make higher hydrocarbon fuels. A lower reaction temperature in step (iii) may be advantageous to minimize heavy ends byproduct formation, by conducting the hydrogenation and hydrogenolysis steps initially at a low temperature. This has been observed to result in an intermediates stream which is rich in diols and polyols, but essentially free of non-hydrogenated monosaccharides which otherwise would serve as heavy ends precursors. The subsequent conversion of mostly solubilized intermediates can be done efficiently at a higher temperature, where residence time is minimized to avoid the undesired continued reaction of monooxygenates to form alkane or alkene byproducts. In this manner, overall yields to desired monooxygenates may be improved, via conducting the conversion in two or more stages.

Solubilization and hydrolysis becoming complete at temperatures around 170° C., aided by organic acids (e.g., carboxylic acids) formed from partial degradation of carbohydrate components. Some lignin can be solubilized before hemicellulose, while other lignin may persist to higher temperatures. Organic in situ generated solvents, which may comprise a portion of the oxygenated intermediates, including, but not limited to, light alcohols and polyols, can assist in solubilization and extraction of lignin and other components.

At temperatures above about 120° C., carbohydrates can degrade through a series of complex self-condensation reactions to form caramelans, which are considered degradation products that are difficult to convert to fuel products. In general, some degradation reactions can be expected with aqueous reaction conditions upon application of temperature, given that water will not completely suppress oligomerization and polymerization reactions.

In certain embodiments, the hydrolysis reaction can occur at a temperature between 20° C. and 250° C. and a pressure between 1 atm and 100 atm. An enzyme may be used for hydrolysis at low temperature and pressure. In embodiments including strong acid and enzymatic hydrolysis, the hydrolysis reaction can occur at temperatures as low as ambient temperature and pressure between 1 atm (100 kPa) and 100 atm (10,100 kPa). In some embodiments, the hydrolysis reaction may comprise a hydrolysis catalyst (e.g., a metal or acid catalyst) to aid in the hydrolysis reaction. The catalyst can be any catalyst capable of effecting a hydrolysis reaction. For example, suitable catalysts can include, but are not limited to, acid catalysts, base catalysts, metal catalysts, and any combination thereof. Acid catalysts can include organic acids such as acetic, formic, levulinic acid, and any combination thereof. In an embodiment the acid catalyst may be generated in the hydrogenolysis reaction and comprise a component of the oxygenated intermediate stream.

In some embodiments, the digestive solvent may contain an in situ generated solvent. The in situ generated solvent generally comprises at least one alcohol, ketone, or polyol capable of solvating some of the sulfur compounds, and nitrogen compounds of the biomass feedstock. For example, an alcohol may be useful for solvating nitrogen, sulfur, and optionally phosphorus compounds, and in solvating lignin from a biomass feedstock for use within the process. The in situ generated solvent may also include one or more organic acids. In some embodiments, the organic acid can act as a catalyst in the removal of nitrogen and sulfur compounds by some hydrolysis of the biomass feedstock. Each in situ generated solvent component may be supplied by an external source, generated within the process, and recycled to the hydrolysis reactor, or any combination thereof. For example, a portion of the oxygenated intermediates produced in the hydrogenolysis reaction may be separated in the separator stage for use as the in situ generated solvent in the hydrolysis reaction. In an embodiment, the in situ generated solvent can be separated, stored, and selectively injected into the recycle stream so as to maintain a desired concentration in the recycle stream.

Each reactor vessel of the invention preferably includes an inlet and an outlet adapted to remove the product stream from the vessel or reactor. In some embodiments, the vessel in which at least some digestion occurs may include additional outlets to allow for the removal of portions of the reactant stream. In some embodiments, the vessel in which at least some digestion occurs may include additional inlets to allow for additional solvents or additives.

The digestion step may occur in any contactor suitable for solid-liquid contacting. The digestion may for example be conducted in a single or multiple vessels, with biomass solids either fully immersed in liquid digestive solvent, or contacted with solvent in a trickle bed or pile digestion mode. As a further example, the digestion step may occur in a continuous multizone contactor as described in U.S. Pat. No. 7,285,179 (Snekkenes et al., “Continuous Digester for Cellulose Pulp including Method and Recirculation System for such Digester”), which disclosure is hereby incorporated by reference. Alternately, the digestion may occur in a fluidized bed or stirred contactor, with suspended solids. The digestion may be conducted batch wise, in the same vessel used for pre-wash, post wash, and/or subsequent reaction steps.

The relative composition of the various carbohydrate components in the treated biomass stream affects the formation of undesirable by-products such as tars or heavy ends in the hydrogenolysis reaction. In particular, a low concentration of carbohydrates present as reducing sugars, or containing free aldehyde groups, in the treated biomass stream can minimize the formation of unwanted by-products. In preferred embodiments, it is desirable to have a concentration of no more than 5 wt %, based upon total liquid, of readily degradable carbohydrates or heavy end precursors in the treated biomass, while maintaining a total organic intermediates concentration, which can include the oxygenated intermediates (e.g., mono-oxygenates, diols, and/or polyols) derived from the carbohydrates, as high as possible, via use of concerted reaction or rapid recycle of the liquid between the digestion zone, and a catalytic reaction zone converting the solubilized carbohydrates to oxygenated intermediates.

For any of the configurations, a substantial portion of lignin is removed with solvent from digesting step. In configuration, the remaining lignin, if present, can be removed upon cooling or partial separation of oxygenates from hydrogenolysis product stream, to comprise a precipitated solids stream. Optionally, the precipitated solids stream containing lignin may be formed by cooling the digested solids stream prior to hydrogenolysis reaction. In yet another configuration, the lignin which is not removed with digestion solvent is passed into step (iv), where it may be precipitated upon vaporization or separation of hydrogenolysis product stream, during processing to product higher hydrocarbons stream 150.

The treated biomass stream 120 may comprise C5 and C6 carbohydrates that can be reacted in the hydrogenolysis reaction. For embodiments comprising hydrogenolysis, oxygenated intermediates such as sugar alcohols, sugar polyols, carboxylic acids, ketones, and/or furans can be converted to fuels in a further processing reaction. The hydrogenolysis reaction comprises hydrogen and a hydrogenolysis catalyst to aid in the reactions taking place. The various reactions can result in the formation of one or more oxygenated intermediate streams 130.

One suitable method for performing hydrogenolysis of carbohydrate-containing biomass includes contacting a carbohydrate or stable hydroxyl intermediate with hydrogen or hydrogen mixed with a suitable gas and a hydrogenolysis catalyst in a hydrogenolysis reaction under conditions effective to form a reaction product comprising smaller molecules or polyols. Most typically, hydrogen is dissolved in the liquid mixture of carbohydrate, which is in contact with the catalyst under conditions to provide catalytic reaction. At least a portion of the carbohydrate feed is contacted directly with hydrogen in the presence of the hydrogenolysis catalyst. By the term “directly”, the reaction is carried out on at least a portion of the carbohydrate without necessary stepwise first converting all of the carbohydrates into a stable hydroxyl intermediate. As used herein, the term “smaller molecules or polyols” includes any molecule that has a lower molecular weight, which can include a smaller number of carbon atoms or oxygen atoms than the starting carbohydrate. In an embodiment, the reaction products include smaller molecules that include polyols and alcohols. This aspect of hydrogenolysis entails breaking of carbon-carbon bonds, where hydrogen is supplied to satisfy bonding requirements for the resulting smaller molecules, as shown for the example:

RC(H)₂—C(H)₂R′+H₂→RCH₃+H₃CR′

where R and R′ are any organic moieties.

In an embodiment, a carbohydrate (e.g., a 5 and/or 6 carbon carbohydrate molecule) can be converted to stable hydroxyl intermediates comprising propylene glycol, ethylene glycol, and glycerol using a hydrogenolysis reaction in the presence of a hydrogenolysis catalyst.

The hydrogenolysis catalyst may includes a support material that has incorporated therein or is loaded with a metal component, which is or can be converted to a metal compound that has activity towards the catalytic hydrogenolysis of soluble carbohydrates. The support material can comprise any suitable inorganic oxide material that is typically used to carry catalytically active metal components. Examples of possible useful inorganic oxide materials include alumina, silica, silica-alumina, magnesia, zirconia, boria, titania and mixtures of any two or more of such inorganic oxides. The preferred inorganic oxides for use in the formation of the support material are alumina, silica, silica-alumina and mixtures thereof. Most preferred, however, is alumina.

In the preparation of the hydrogenolysis catalyst, the metal component of the catalyst composition may be incorporated into the support material by any suitable method or means that provides the support material that is loaded with an active metal precursor, thus, the composition includes the support material and a metal component. One method of incorporating the metal component into the support material, includes, for example, co-mulling the support material with the active metal or metal precursor to yield a co-mulled mixture of the two components. Or, another method includes the co-precipitation of the support material and metal component to form a co-precipitated mixture of the support material and metal component. Or, in a preferred method, the support material is impregnated with the metal component using any of the known impregnation methods such as incipient wetness to incorporate the metal component into the support material.

When using the impregnation method to incorporate the metal component into the support material, it is preferred for the support material to be formed into a shaped particle comprising an inorganic oxide material and thereafter loaded with an active metal precursor, preferably, by the impregnation of the shaped particle with an aqueous solution of a metal salt to give the support material containing a metal of a metal salt solution. To form the shaped particle, the inorganic oxide material, which preferably is in powder form, is mixed with water and, if desired or needed, a peptizing agent and/or a binder to form a mixture that can be shaped into an agglomerate. It is desirable for the mixture to be in the form of an extrudable paste suitable for extrusion into extrudate particles, which may be of various shapes such as cylinders, trilobes, etc. and nominal sizes such as 1/16″, ⅛″, 3/16″, etc. The support material of the inventive composition, thus, preferably, is a shaped particle comprising an inorganic oxide material.

The calcined shaped particle can have a surface area (determined by the BET method employing N₂, ASTM test method D 3037) that is in the range of from about 50 m²/g to about 450 m²/g, preferably from about 75 m²/g to about 400 m²/g, and, most preferably, from about 100 m²/g to about 350 m²/g. The mean pore diameter in angstroms (Å) of the calcined shaped particle is in the range of from about 50 to about 200, preferably, from about 70 to about 150, and, most preferably, from about 75 to about 125. The pore volume of the calcined shaped particle is in the range of from about 0.5 cc/g to about 1.1 cc/g, preferably, from about 0.6 cc/g to about 1.0 cc/g, and, most preferably, from about 0.7 to about 0.9 cc/g. Less than ten percent (10%) of the total pore volume of the calcined shaped particle is contained in the pores having a pore diameter greater than about 350 Å, preferably, less than about 7.5% of the total pore volume of the calcined shaped particle is contained in the pores having a pore diameter greater than about 350 Å, and, most preferably, less than about 5%.

The references herein to the pore size distribution and pore volume of the calcined shaped particle are to those properties as determined by mercury intrusion porosimetry, ASTM test method D 4284. The measurement of the pore size distribution of the calcined shaped particle is by any suitable measurement instrument using a contact angle of 140° with a mercury surface tension of 474 dyne/cm at 25° C.

In one embodiment, the calcined shaped particle is impregnated in one or more impregnation steps with a metal component using one or more aqueous solutions containing at least one metal salt wherein the metal compound of the metal salt solution is an active metal or active metal precursor. The metal elements are (a) molybdenum (Mo) and (b) cobalt (Co) and/or nickel (Ni). Phosphorous (P) can also be a desired metal component. For Co and Ni, the metal salts include metal acetates, formats, citrates, oxides, hydroxides, carbonates, nitrates, sulfates, and two or more thereof. The preferred metal salts are metal nitrates, for example, such as nitrates of nickel or cobalt, or both. For Mo, the metal salts include metal oxides or sulfides. Preferred are salts containing the Mo and ammonium ion, such as ammonium heptamolybdate and ammonium dimolybdate.

Phosphorus is an additive that may be incorporated in these catalysts. Phosphorus may be added to increase the solubility of the molybdenum and to allow stable solutions of cobalt and/or nickel with the molybdenum to be formed for impregnation. Without wishing to be bound by theory, it is thought that Phosphorus may also promote hydrogenation and hydrodenitrogenation (HDN). The ability to promote HDN is an important one since nitrogen compounds are known inhibitors of the HDS reaction. The addition of phosphorus to these catalysts may increase the HDN activity and therefore increases the HDS activity as a result of removal of the nitrogen inhibitors from the reaction medium. The ability of phosphorus to also promote hydrogenation is also advantageous for HDS since some of the difficult, sterically hindered sulfur molecules are mainly desulfurized via an indirect mechanistic pathway that goes through an initial hydrogenation of the aromatic rings in these molecules. The promotion of the hydrogenation activity of these catalysts by phosphorus increases the desulfurization of these types of sulfur containing molecules. The phosphorus content of the finished catalyst is typically in a range from 0.1 to 5.0 wt %.

The concentration of the metal compounds in the impregnation solution is selected so as to provide the desired metal content in the final composition of the hydrogenolysis catalyst taking into consideration the pore volume of the support material into which the aqueous solution is to be impregnated. Typically, the concentration of metal compound in the impregnation solution is in the range of from 0.01 to 100 moles per liter.

Cobalt, nickel, or combination thereof can be present in the support material having a metal component incorporated therein in an amount in the range of from about 0.5 wt. % to about 20 wt. %, preferably from about 1 wt. % to about 15 wt. %, and, most preferably, from about 2 wt. % to about 12 wt. %, based on metals components (b) and (c) as metal oxide form; and the Molybdenum can be present in the support material having a metal component incorporated therein in an amount in the range of from about 2 wt. % to about 50 wt. %, preferably from about 5 wt. % to about 40 wt. %, and, most preferably, from about 12 wt. % to about 30 wt. %, based on metals components (b) and (c) as metal oxide form. The above-referenced weight percents for the metal components are based on the dry support material and the metal component as the element (change “element” to “metal oxide form”) regardless of the actual form of the metal component.

The metal loaded catalyst may be sulfided prior to its loading into a reactor vessel or system for its use as hydrogenolysis catalyst or may be sulfided, in situ, in a gas phase or liquid phase activation procedure. In one embodiment, the liquid soluble carbohydrate feedstock can be contacted with a sulfur-containing compound, which can be hydrogen sulfide or a compound that is decomposable into hydrogen sulfide, under the contacting conditions of the invention. Examples of such decomposable compounds include mercaptans, CS₂, thiophenes, dimethyl sulfide (DMS), dimethyl sulfoxide (DMSO), sodium hydrogen sulfate, and dimethyl disulfide (DMDS). Also, preferably, the sulfiding is accomplished by contacting the hydrogen treated composition, under suitable sulfurization treatment conditions, with a suitable feedsource that contains a concentration of a sulfur compound. The sulfur compound of the hydrocarbon feedstock can be an organic sulfur compound, particularly, one that is derived from the biomass feedstock or other sulfur containing amino-acids such as Cysteine.

Suitable sulfurization treatment conditions are those which provide for the conversion of the active metal components of the precursor hydrogenolysis catalyst to their sulfided form. Typically, the sulfiding temperature at which the precursor hydrogenolysis catalyst is contacted with the sulfur compound is in the range of from about 150° C. to about 450° C., preferably, from about 175° C. to about 425° C., and, most preferably, from about 200° C. to about 400° C.

When using a soluble carbohydrate feedstock that is to be treated using the catalyst to sulfide, the sulfurization conditions can be the same as the process conditions under which the hydrogenolysis is performed. The sulfiding pressure generally can be in the range of from about 1 bar to about 70 bar, preferably, from about 1.5 bar to about 55 bar, and, most preferably, from about 2 bar to about 35 bar. The resulting active catalyst typically has incorporated therein sulfur content in an amount in the range of from about 0.1 wt. % to about 40 wt. %, preferably from about 1 wt. % to about 30 wt. %, and, most preferably, from about 3 wt. % to about 24 wt. %, based on metals components (b) and (c) as metal oxide form.

The conditions for which to carry out the hydrogenolysis reaction will vary based on the type of biomass starting material and the desired products (e.g. gasoline or diesel). One of ordinary skill in the art, with the benefit of this disclosure, will recognize the appropriate conditions to use to carry out the reaction. In general, the hydrogenolysis reaction is conducted at temperatures in the range of 110° C. to 300° C., and preferably of 170° C. to 300° C., and most preferably of 180° C. to 290° C.

In an embodiment, the hydrogenolysis reaction is conducted under basic conditions, preferably at a pH of 8 to 13, and even more preferably at a pH of 10 to 12. In another embodiment, the hydrogenolysis reaction is conducted under neutral conditions.

In an embodiment, the hydrogenolysis reaction is conducted at pressures in a range between 60 kPa and 16500 kPa, and preferably in a range between 1700 kPa and 14000 kPa, and even more preferably between 4800 kPa and 11000 kPa.

The hydrogen used in the hydrogenolysis reaction of the current invention can include external hydrogen, recycled hydrogen, in situ generated hydrogen, and any combination thereof.

In an embodiment, the use of a hydrogenolysis reaction may produce less carbon dioxide and a greater amount of polyols than a reaction that results in reforming of the reactants. For example, reforming can be illustrated by formation of isopropanol (i.e., IPA, or 2-propanol) from sorbitol:

C₆H₁₄O₆+H₂O→4H₂+3CO₂+C₃H₈O;dHR=−40 J/g-mol (Eq. 1)

Alternately, in the presence of hydrogen, polyols and mono-oxygenates such as IPA can be formed by hydrogenolysis, where hydrogen is consumed rather than produced:

C₆H₁₄O₆+3H₂→2H₂O+2C₃H₈O₂;dHR=+81 J/gmol (Eq. 2)

C₆H₁₄O₆+5H₂→4H₂O+2C₃H₈O;dHR=−339 J/gmol (Eq. 3)

As a result of the differences in the reaction conditions (e.g., presence of hydrogen), the products of the hydrogenolysis reaction may comprise greater than 25% by mole, or alternatively, greater than 30% by mole of polyols, which may result in a greater conversion in a subsequent processing reaction. In addition, the use of a hydrolysis reaction rather than a reaction running at reforming conditions may result in less than 20% by mole, or alternatively less than 30% by mole carbon dioxide production. As used herein, “oxygenated intermediates” generically refers to hydrocarbon compounds having one or more carbon atoms and between one and three oxygen atoms (referred to herein as C1+O1-3 hydrocarbons), such as polyols and smaller molecules (e.g., one or more polyols, alcohols, ketones, or any other hydrocarbon having at least one oxygen atom).

In an embodiment, hydrogenolysis is conducted under neutral or acidic conditions, as needed to accelerate hydrolysis reactions in addition to the hydrogenolysis. Hydrolysis of oligomeric carbohydrates may be combined with hydrogenation to produce sugar alcohols, which can undergo hydrogenolysis.

A second aspect of hydrogenolysis entails the breaking of —OH bonds such as:

RC(H)₂—OH+H₂→RCH₃+H₂O

This reaction is also called “hydrodeoxygenation”, and may occur in parallel with C—C bond breaking hydrogenolysis. Diols may be converted to mono-oxygenates via this reaction. As reaction severity is increased by increases in temperature or contact time with catalyst, the concentration of polyols and diols relative to mono-oxygenates will diminish, as a result of this reaction. Selectivity for C—C vs. C—OH bond hydrogenolysis will vary with catalyst type and formulation. Full de-oxygenation to alkanes can also occur, but is generally undesirable if the intent is to produce monooxygenates or diols and polyols which can be condensed or oligomerized to higher molecular weight fuels, in a subsequent processing step. Typically, it is desirable to send only mono-oxygenates or diols to subsequent processing steps, as higher polyols can lead to excessive coke formation on condensation or oligomerization catalysts, while alkanes are essentially unreactive and cannot be combined to produce higher molecular weight fuels.

Thus, in the reaction zone the reaction mixture may contain:
(i) lignocellulosic biomass;
(ii) a hydrogenolysis catalyst containing (a) sulfur, (b) Mo or W, and (c) Co, Ni or mixture thereof, and (d) phosphorus, incorporated into a suitable support;
(iii) water; and
(iv) a digestive solvent.
   In some embodiment, the composition may further comprise (v) carbohydrates or sugar alcohols.

In an embodiment of the invention, the pretreated biomass containing carbohydrates may be converted into an stable hydroxyl intermediate comprising the corresponding alcohol derivative through a hydrogenolysis reaction in addition to an optional hydrogenation reaction in a suitable reaction vessel (such as hydrogenation reaction as described in co-pending patent application publication nos. US20110154721 and US20110282115 which disclosures are hereby incorporated by reference).

The oxygenated intermediate stream 130 may then pass from the hydrogenolysis system to a further processing stage 136. In some embodiments, optional separation stage includes elements that allow for the separation of the oxygenated intermediates into different components. In some embodiments of the present invention, the separation stage can receive the oxygenated intermediate stream 130 from the hydrogenolysis reaction and separate the various components into two or more streams. For example, a suitable separator may include, but is not limited to, a phase separator, stripping column, extractor, filter, or distillation column. In some embodiments, a separator is installed prior to a processing reaction to favor production of higher hydrocarbons by separating the higher polyols from the oxygenated intermediates. In such an embodiment, the higher polyols can be recycled back through to the hydrogenolysis reaction, while the other oxygenated intermediates are passed to the processing reaction 136. In addition, an outlet stream from the separation stage containing a portion of the oxygenated intermediates may act as in situ generated digestive solvent when recycled to the digester 106. In one embodiment, the separation stage can also be used to remove some or all of the lignin from the oxygenated intermediate stream. The lignin may be passed out of the separation stage as a separate stream, for example as output stream.

In some embodiments, the oxygenated intermediates can be converted into higher hydrocarbons through a processing reaction shown schematically as processing reaction 136 in FIG. 3. In an embodiment, the processing reaction may comprise a condensation reaction to produce a fuel blend. In an embodiment, the higher hydrocarbons may be part of a fuel blend for use as a transportation fuel. In such an embodiment, condensation of the oxygenated intermediates occurs in the presence of a catalyst capable of forming higher hydrocarbons. While not intending to be limited by theory, it is believed that the production of higher hydrocarbons proceeds through a stepwise addition reaction including the formation of carbon-carbon bond. The resulting reaction products include any number of compounds, as described in more detail below.

Referring to FIG. 1, in some embodiments, an outlet stream 130 containing at least a portion of the oxygenated intermediates can pass to a processing reaction or processing reactions. Suitable processing reactions may comprise a variety of catalysts for condensing one or more oxygenated intermediates to higher hydrocarbons, defined as hydrocarbons containing more carbons than the oxygenated intermediate precursors. The higher hydrocarbons may comprise a fuel product. The fuel products produced by the processing reactions represent the product stream from the overall process at higher hydrocarbon stream 150. In an embodiment, the oxygen to carbon ratio of the higher hydrocarbons produced through the processing reactions is less than 0.5, alternatively less than 0.4, or preferably less than 0.3.

The oxygenated intermediates can be processed to produce a fuel blend in one or more processing reactions. In an embodiment, a condensation reaction can be used along with other reactions to generate a fuel blend and may be catalyzed by a catalyst comprising acid or basic functional sites, or both. In general, without being limited to any particular theory, it is believed that the basic condensation reactions generally consist of a series of steps involving: (1) an optional dehydrogenation reaction; (2) an optional dehydration reaction that may be acid catalyzed; (3) an aldol condensation reaction; (4) an optional ketonization reaction; (5) an optional furanic ring opening reaction; (6) hydrogenation of the resulting condensation products to form a C4+ hydrocarbon; and (7) any combination thereof. Acid catalyzed condensations may similarly entail optional hydrogenation or dehydrogenation reactions, dehydration, and oligomerization reactions. Additional polishing reactions may also be used to conform the product to a specific fuel standard, including reactions conducted in the presence of hydrogen and a hydrogenation catalyst to remove functional groups from final fuel product. A catalyst comprising a basic functional site, both an acid and a basic functional site, and optionally comprising a metal function, may be used to effect the condensation reaction.

“Acidic” conditions or “acidic functionality” for the catalysts refer to either Bronsted or Lewis acid acidity. For Bronsted acidity, the catalyst is capable of donating protons (designed as H⁺) to perform the catalytic reaction, under the conditions present in the catalytic reactor. Acidic ion exchange resins, phosphoric acid present as a liquid phase on a support, are two examples. Metal oxides such as silica, silica-aluminas, promoted zirconia or titania can provide protons H⁺ associated with Bronsted acidity in the presence of water or water vapor. Lewis acidity entails ability to accept an electron pair, and most typically is obtained via the presence of metal cations in a mixed metal-oxide framework such as silica-alumina or zeolite. Determination of acidic properties can be done via adsorption of a base such as ammonia, use of indictors, or via use of a probe reaction such as dehydration of an alcohol to an olefin, which is acid catalyzed. “Basic” conditions or “base functionality” for the catalysts can refer to either Bronsted or Lewis basicity. For Bronsted basicity, hydroxide anion is supplied by the catalyst, which may be present as an ion exchange resin, or supported liquid phase catalyst, mixed metal oxide with promoter such as alkali, calcium, or magnesium, or in free solution. Lewis base catalysis refers to the conditions where Lewis base catalysis is the process by which an electron pair donor increases the rate of a given chemical reaction by interacting with an acceptor atom in one of the reagents or substrate (see Scott E. Denmark and Gregory L. Beutner, Lewis Base Catalysis in Organic Synthesis, Angew. Chem. Int. Ed. 2008, 47, 1560-1638). Presence and characterization of basic sites for a heterogeneous catalyst may be determined via sorption of an acidic component, use of probe reactions, or use of indicators. (see K. Tanabe, M. Misono, Y. Ono, H. Hattori (Eds.), New Solid Acids and Bases, Kodansha/Elsevier, Tokyo/Amsterdam, 1989, pp. 260-267). Catalysts such as mixed metal oxides may be “amphoteric”, or capable of acting as acidic or basic catalysts depending on process conditions (pH, water concentration), or exhibit both acidic and basic properties under specific operating conditions, as a result of surface structures generated during formulation, or in situ during use to effect catalytic reactions.

In an embodiment, a method of forming a fuel blend from a biomass feedstock may comprise a digester that receives a biomass feedstock and a digestive solvent operating under conditions to effectively to produce soluble carbohydrate containing nitrogen compounds and sulfur compounds; a hydrogenolysis reactor comprising a supported hydrogenolysis catalyst containing sulfur and Mo or W and Co and/or Ni that receives the treated stream and discharges an oxygenated intermediate stream, wherein a first portion of the oxygenated intermediate stream is recycled to the digester as at least a portion of the digestive solvent; and a fuels processing reactor comprising a condensation catalyst that receives a second portion of the oxygenated intermediate stream and discharges a liquid fuel.

In an embodiment, the aldol condensation reaction may be used to produce a fuel blend meeting the requirements for a diesel fuel or jet fuel. Traditional diesel fuels are petroleum distillates rich in paraffinic hydrocarbons. They have boiling ranges as broad as 187° C. to 417° C., which are suitable for combustion in a compression ignition engine, such as a diesel engine vehicle. The American Society of Testing and Materials (ASTM) establishes the grade of diesel according to the boiling range, along with allowable ranges of other fuel properties, such as cetane number, cloud point, flash point, viscosity, aniline point, sulfur content, water content, ash content, copper strip corrosion, and carbon residue. Thus, any fuel blend meeting ASTM D975 can be defined as diesel fuel.

The present invention also provides methods to produce jet fuel. Jet fuel is clear to straw colored. The most common fuel is an unleaded/paraffin oil-based fuel classified as Aeroplane A-1, which is produced to an internationally standardized set of specifications. Jet fuel is a mixture of a large number of different hydrocarbons, possibly as many as a thousand or more. The range of their sizes (molecular weights or carbon numbers) is restricted by the requirements for the product, for example, freezing point or smoke point. Kerosene-type Airplane fuel (including Jet A and Jet A-1) has a carbon number distribution between about C8 and C16. Wide-cut or naphtha-type Airplane fuel (including Jet B) typically has a carbon number distribution between about C5 and C15. A fuel blend meeting ASTM D1655 can be defined as jet fuel.

In certain embodiments, both Airplanes (Jet A and Jet B) contain a number of additives. Useful additives include, but are not limited to, antioxidants, antistatic agents, corrosion inhibitors, and fuel system icing inhibitor (FSII) agents. Antioxidants prevent gumming and usually, are based on alkylated phenols, for example, AO-30, AO-31, or AO-37. Antistatic agents dissipate static electricity and prevent sparking. Stadis 450 with dinonylnaphthylsulfonic acid (DINNSA) as the active ingredient, is an example. Corrosion inhibitors, e.g., DCI-4A are used for civilian and military fuels and DCI-6A is used for military fuels. FSII agents, include, e.g., Di-EGME.

In an embodiment, the oxygenated intermediates may comprise a carbonyl-containing compound that can take part in a base catalyzed condensation reaction. In some embodiments, an optional dehydrogenation reaction may be used to increase the amount of carbonyl-containing compounds in the oxygenated intermediate stream to be used as a feed to the condensation reaction. In these embodiments, the oxygenated intermediates and/or a portion of the bio-based feedstock stream can be dehydrogenated in the presence of a catalyst.

In an embodiment, a dehydrogenation catalyst may be preferred for an oxygenated intermediate stream comprising alcohols, diols, and triols. In general, alcohols cannot participate in aldol condensation directly. The hydroxyl group or groups present can be converted into carbonyls (e.g., aldehydes, ketones, etc.) in order to participate in an aldol condensation reaction. A dehydrogenation catalyst may be included to effect dehydrogenation of any alcohols, diols, or polyols present to form ketones and aldehydes. The dehydration catalyst is typically formed from the same metals as used for hydrogenation, hydrogenolysis, or aqueous phase reforming, which catalysts are described in more detail above. Dehydrogenation yields are enhanced by the removal or consumption of hydrogen as it forms during the reaction. The dehydrogenation step may be carried out as a separate reaction step before an aldol condensation reaction, or the dehydrogenation reaction may be carried out in concert with the aldol condensation reaction. For concerted dehydrogenation and aldol condensation, the dehydrogenation and aldol condensation functions can be on the same catalyst. For example, a metal hydrogenation/dehydrogenation functionality may be present on catalyst comprising a basic functionality.

The dehydrogenation reaction may result in the production of a carbonyl-containing compound. Suitable carbonyl-containing compounds include, but are not limited to, any compound comprising a carbonyl functional group that can form carbanion species or can react in a condensation reaction with a carbanion species, where “carbonyl” is defined as a carbon atom doubly-bonded to oxygen. In an embodiment, a carbonyl-containing compound can include, but is not limited to, ketones, aldehydes, furfurals, hydroxy carboxylic acids, and, carboxylic acids. The ketones may include, without limitation, hydroxyketones, cyclic ketones, diketones, acetone, propanone, 2-oxopropanal, butanone, butane-2,3-dione, 3-hydroxybutane-2-one, pentanone, cyclopentanone, pentane-2,3-dione, pentane-2,4-dione, hexanone, cyclohexanone, 2-methyl-cyclopentanone, heptanone, octanone, nonanone, decanone, undecanone, dodecanone, methylglyoxal, butanedione, pentanedione, diketohexane, dihydroxyacetone, and isomers thereof. The aldehydes may include, without limitation, hydroxyaldehydes, acetaldehyde, glyceraldehyde, propionaldehyde, butyraldehyde, pentanal, hexanal, heptanal, octanal, nonal, decanal, undecanal, dodecanal, and isomers thereof. The carboxylic acids may include, without limitation, formic acid, acetic acid, propionic acid, butanoic acid, pentanoic acid, hexanoic acid, heptanoic acid, isomers and derivatives thereof, including hydroxylated derivatives, such as 2-hydroxybutanoic acid and lactic acid. Furfurals include, without limitation, hydroxylmethylfurfural, 5-hydroxymethyl-2(5H)-furanone, dihydro-5-(hydroxymethyl)-2(3H)-furanone, tetrahydro-2-furoic acid, dihydro-5-(hydroxymethyl)-2(3H)-furanone, tetrahydrofurfuryl alcohol, 1-(2-furyl)ethanol, hydroxymethyltetrahydrofurfural, and isomers thereof. In an embodiment, the dehydrogenation reaction results in the production of a carbonyl-containing compound that is combined with the oxygenated intermediates to become a part of the oxygenated intermediates fed to the condensation reaction.

In an embodiment, an acid catalyst may be used to optionally dehydrate at least a portion of the oxygenated intermediate stream. Suitable acid catalysts for use in the dehydration reaction include, but are not limited to, mineral acids (e.g., HCl, H₂SO₄), solid acids (e.g., zeolites, ion-exchange resins) and acid salts (e.g., LaCl3). Additional acid catalysts may include, without limitation, zeolites, carbides, nitrides, zirconia, alumina, silica, aluminosilicates, phosphates, titanium oxides, zinc oxides, vanadium oxides, lanthanum oxides, yttrium oxides, scandium oxides, magnesium oxides, cerium oxides, barium oxides, calcium oxides, hydroxides, heteropolyacids, inorganic acids, acid modified resins, base modified resins, and any combination thereof. In some embodiments, the dehydration catalyst can also include a modifier. Suitable modifiers include La, Y, Sc, P, B, Bi, Li, Na, K, Rb, Cs, Mg, Ca, Sr, Ba, and any combination thereof. The modifiers may be useful, inter alia, to carry out a concerted hydrogenation/dehydrogenation reaction with the dehydration reaction. In some embodiments, the dehydration catalyst can also include a metal. Suitable metals include Cu, Ag, Au, Pt, Ni, Fe, Co, Ru, Zn, Cd, Ga, In, Rh, Pd, Ir, Re, Mn, Cr, Mo, W, Sn, Os, alloys, and any combination thereof. The dehydration catalyst may be self supporting, supported on an inert support or resin, or it may be dissolved in solution.

In some embodiments, the dehydration reaction occurs in the vapor phase. In other embodiments, the dehydration reaction occurs in the liquid phase. For liquid phase dehydration reactions, an aqueous solution may be used to carry out the reaction. In an embodiment, other solvents in addition to water, are used to form the aqueous solution. For example, water soluble organic solvents may be present. Suitable solvents can include, but are not limited to, hydroxymethylfurfural (HMF), dimethylsulfoxide (DMSO), 1-methyl-n-pyrollidone (NMP), and any combination thereof. Other suitable aprotic solvents may also be used alone or in combination with any of these solvents.

In an embodiment, the processing reactions may comprise an optional ketonization reaction. A ketonization reaction may increase the number of ketone functional groups within at least a portion of the oxygenated intermediate stream. For example, an alcohol or other hydroxyl functional group can be converted into a ketone in a ketonization reaction. Ketonization may be carried out in the presence of a base catalyst. Any of the base catalysts described above as the basic component of the aldol condensation reaction can be used to effect a ketonization reaction. Suitable reaction conditions are known to one of ordinary skill in the art and generally correspond to the reaction conditions listed above with respect to the aldol condensation reaction. The ketonization reaction may be carried out as a separate reaction step, or it may be carried out in concert with the aldol condensation reaction. The inclusion of a basic functional site on the aldol condensation catalyst may result in concerted ketonization and aldol condensation reactions.

In an embodiment, the processing reactions may comprise an optional furanic ring opening reaction. A furanic ring opening reaction may result in the conversion of at least a portion of any oxygenated intermediates comprising a furanic ring into compounds that are more reactive in an aldol condensation reaction. A furanic ring opening reaction may be carried out in the presence of an acidic catalyst. Any of the acid catalysts described above as the acid component of the aldol condensation reaction can be used to effect a furanic ring opening reaction. Suitable reaction conditions are known to one of ordinary skill in the art and generally correspond to the reaction conditions listed above with respect to the aldol condensation reaction. The furanic ring opening reaction may be carried out as a separate reaction step, or it may be carried out in concert with the aldol condensation reaction. The inclusion of an acid functional site on the aldol condensation catalyst may result in a concerted furanic ring opening reaction and aldol condensation reactions. Such an embodiment may be advantageous as any furanic rings can be opened in the presence of an acid functionality and reacted in an aldol condensation reaction using a base functionality. Such a concerted reaction scheme may allow for the production of a greater amount of higher hydrocarbons to be formed for a given oxygenated intermediate feed.

In an embodiment, production of a C4+ compound occurs by condensation, which may include aldol-condensation, of the oxygenated intermediates in the presence of a condensation catalyst. Aldol-condensation generally involves the carbon-carbon coupling between two compounds, at least one of which may contain a carbonyl group, to form a larger organic molecule. For example, acetone may react with hydroxymethylfurfural to form a C9 species, which may subsequently react with another hydroxymethylfurfural molecule to form a C15 species. The reaction is usually carried out in the presence of a condensation catalyst. The condensation reaction may be carried out in the vapor or liquid phase. In an embodiment, the reaction may take place at a temperature in the range of from about 7° C. to about 377° C., depending on the reactivity of the carbonyl group.

The condensation catalyst will generally be a catalyst capable of forming longer chain compounds by linking two molecules through a new carbon-carbon bond, such as a basic catalyst, a multi-functional catalyst having both acid and base functionality, or either type of catalyst also comprising an optional metal functionality. In an embodiment, the multi-functional catalyst will be a catalyst having both a strong acid and a strong base functionality. In an embodiment, aldol catalysts can comprise Li, Na, K, Cs, B, Rb, Mg, Ca, Sr, Si, Ba, Al, Zn, Ce, La, Y, Sc, Y, Zr, Ti, hydrotalcite, zinc-aluminate, phosphate, base-treated aluminosilicate zeolite, a basic resin, basic nitride, alloys or any combination thereof. In an embodiment, the base catalyst can also comprise an oxide of Ti, Zr, V, Nb, Ta, Mo, Cr, W, Mn, Re, Al, Ga, In, Co, Ni, Si, Cu, Zn, Sn, Cd, Mg, P, Fe, or any combination thereof. In an embodiment, the condensation catalyst comprises mixed-oxide base catalysts. Suitable mixed-oxide base catalysts can comprise a combination of magnesium, zirconium, and oxygen, which may comprise, without limitation: Si—Mg—O, Mg—Ti—O, Y—Mg—O, Y—Zr—O, Ti—Zr—O, Ce—Zr—O, Ce—Mg—O, Ca—Zr—O, La—Zr—O, B—Zr—O, La—Ti—O, B—Ti—O, and any combinations thereof. Different atomic ratios of Mg/Zr or the combinations of various other elements constituting the mixed oxide catalyst may be used ranging from about 0.01 to about 50. In an embodiment, the condensation catalyst further includes a metal or alloys comprising metals, such as Cu, Ag, Au, Pt, Ni, Fe, Co, Ru, Zn, Cd, Ga, In, Rh, Pd, Ir, Re, Mn, Cr, Mo, W, Sn, Bi, Pb, Os, alloys and combinations thereof. Such metals may be preferred when a dehydrogenation reaction is to be carried out in concert with the aldol condensation reaction. In an embodiment, preferred Group IA materials include Li, Na, K, Cs and Rb. In an embodiment, preferred Group IIA materials include Mg, Ca, Sr and Ba. In an embodiment, Group IIB materials include Zn and Cd. In an embodiment, Group IIIB materials include Y and La. Basic resins include resins that exhibit basic functionality. The base catalyst may be self-supporting or adhered to any one of the supports further described below, including supports containing carbon, silica, alumina, zirconia, titania, vanadia, ceria, nitride, boron nitride, heteropolyacids, alloys and mixtures thereof.

In one embodiment, the condensation catalyst is derived from the combination of MgO and Al₂O₃ to form a hydrotalcite material. Another preferred material contains ZnO and Al₂O₃ in the form of a zinc aluminate spinel. Yet another preferred material is a combination of ZnO, Al₂O₃, and CuO. Each of these materials may also contain an additional metal function provided by a Group VIIIB metal, such as Pd or Pt. Such metals may be preferred when a dehydrogenation reaction is to be carried out in concert with the aldol condensation reaction. In one embodiment, the base catalyst is a metal oxide containing Cu, Ni, Zn, V, Zr, or mixtures thereof. In another embodiment, the base catalyst is a zinc aluminate metal containing Pt, Pd Cu, Ni, or mixtures thereof.

Preferred loading of the primary metal in the condensation catalyst is in the range of 0.10 wt % to 25 wt %, with weight percentages of 0.10% and 0.05% increments between, such as 1.00%, 1.10%, 1.15%, 2.00%, 2.50%, 5.00%, 10.00%, 12.50%, 15.00% and 20.00%. The preferred atomic ratio of the second metal, if any, is in the range of 0.25-to-1 to 10-to-1, including ratios there between, such as 0.50, 1.00, 2.50, 5.00, and 7.50-to-1.

In some embodiments, the base catalyzed condensation reaction is performed using a condensation catalyst with both an acid and base functionality. The acid-aldol condensation catalyst may comprise hydrotalcite, zinc-aluminate, phosphate, Li, Na, K, Cs, B, Rb, Mg, Si, Ca, Sr, Ba, Al, Ce, La, Sc, Y, Zr, Ti, Zn, Cr, or any combination thereof. In further embodiments, the acid-base catalyst may also include one or more oxides from the group of Ti, Zr, V, Nb, Ta, Mo, Cr, W, Mn, Re, Al, Ga, In, Fe, Co, Ir, Ni, Si, Cu, Zn, Sn, Cd, P, and combinations thereof. In an embodiment, the acid-base catalyst includes a metal functionality provided by Cu, Ag, Au, Pt, Ni, Fe, Co, Ru, Zn, Cd, Ga, In, Rh, Pd, Ir, Re, Mn, Cr, Mo, W, Sn, Os, alloys or combinations thereof. In one embodiment, the catalyst further includes Zn, Cd or phosphate. In one embodiment, the condensation catalyst is a metal oxide containing Pd, Pt, Cu or Ni, and even more preferably an aluminate or zirconium metal oxide containing Mg and Cu, Pt, Pd or Ni. The acid-base catalyst may also include a hydroxyapatite (HAP) combined with any one or more of the above metals. The acid-base catalyst may be self-supporting or adhered to any one of the supports further described below, including supports containing carbon, silica, alumina, zirconia, titania, vanadia, ceria, nitride, boron nitride, heteropolyacids, alloys and mixtures thereof.

In an embodiment, the condensation catalyst may also include zeolites and other microporous supports that contain Group IA compounds, such as Li, NA, K, Cs and Rb. Preferably, the Group IA material is present in an amount less than that required to neutralize the acidic nature of the support. A metal function may also be provided by the addition of group VIIIB metals, or Cu, Ga, In, Zn or Sn. In one embodiment, the condensation catalyst is derived from the combination of MgO and Al₂O₃ to form a hydrotalcite material. Another preferred material contains a combination of MgO and ZrO₂, or a combination of ZnO and Al₂O₃. Each of these materials may also contain an additional metal function provided by copper or a Group VIIIB metal, such as Ni, Pd, Pt, or combinations of the foregoing.

If a Group IIB, VIIB, VIIB, VIIIB, IIA or IVA metal is included in the condensation catalyst, the loading of the metal is in the range of 0.10 wt % to 10 wt %, with weight percentages of 0.10% and 0.05% increments between, such as 1.00%, 1.10%, 1.15%, 2.00%, 2.50%, 5.00% and 7.50%, etc. If a second metal is included, the preferred atomic ratio of the second metal is in the range of 0.25-to-1 to 5-to-1, including ratios there between, such as 0.50, 1.00, 2.50 and 5.00-to-1.

The condensation catalyst may be self-supporting (i.e., the catalyst does not need another material to serve as a support), or may require a separate support suitable for suspending the catalyst in the reactant stream. One exemplary support is silica, especially silica having a high surface area (greater than 100 square meters per gram), obtained by sol-gel synthesis, precipitation, or fuming. In other embodiments, particularly when the condensation catalyst is a powder, the catalyst system may include a binder to assist in forming the catalyst into a desirable catalyst shape. Applicable forming processes include extrusion, pelletization, oil dropping, or other known processes. Zinc oxide, alumina, and a peptizing agent may also be mixed together and extruded to produce a formed material. After drying, this material is calcined at a temperature appropriate for formation of the catalytically active phase, which usually requires temperatures in excess of 452° C. Other catalyst supports as known to those of ordinary skill in the art may also be used.

In some embodiments, a dehydration catalyst, a dehydrogenation catalyst, and the condensation catalyst can be present in the same reactor as the reaction conditions overlap to some degree. In these embodiments, a dehydration reaction and/or a dehydrogenation reaction may occur substantially simultaneously with the condensation reaction. In some embodiments, a catalyst may comprise active sites for a dehydration reaction and/or a dehydrogenation reaction in addition to a condensation reaction. For example, a catalyst may comprise active metals for a dehydration reaction and/or a dehydrogenation reaction along with a condensation reaction at separate sites on the catalyst or as alloys. Suitable active elements can comprise any of those listed above with respect to the dehydration catalyst, dehydrogenation catalyst, and the condensation catalyst. Alternately, a physical mixture of dehydration, dehydrogenation, and condensation catalysts could be employed. While not intending to be limited by theory, it is believed that using a condensation catalyst comprising a metal and/or an acid functionality may assist in pushing the equilibrium limited aldol condensation reaction towards completion. Advantageously, this can be used to effect multiple condensation reactions with dehydration and/or dehydrogenation of intermediates, in order to form (via condensation, dehydration, and/or dehydrogenation) higher molecular weight oligomers as desired to produce jet or diesel fuel.

The specific C4+ compounds produced in the condensation reaction will depend on various factors, including, without limitation, the type of oxygenated intermediates in the reactant stream, condensation temperature, condensation pressure, the reactivity of the catalyst, and the flow rate of the reactant stream as it affects the space velocity, GHSV and WHSV. Preferably, the reactant stream is contacted with the condensation catalyst at a WHSV that is appropriate to produce the desired hydrocarbon products. The WHSV is preferably at least about 0.1 grams of oxygenated intermediates in the reactant stream per hour, more preferably the WHSV is between about 0.1 to 40.0 g/g hr, including a WHSV of about 1, 2, 3, 4, 5, 6, 7, 8, 9, 10, 11, 12, 13, 14, 15, 20, 25, 30, 35 g/g hr, and increments between.

In general, the condensation reaction should be carried out at a temperature at which the thermodynamics of the proposed reaction are favorable. For condensed phase liquid reactions, the pressure within the reactor must be sufficient to maintain at least a portion of the reactants in the condensed liquid phase at the reactor inlet. For vapor phase reactions, the reaction should be carried out at a temperature where the vapor pressure of the oxygenates is at least about 10 kPa, and the thermodynamics of the reaction are favorable. The condensation temperature will vary depending upon the specific oxygenated intermediates used, but is generally in the range of from about 77° C. to 502° C. for reactions taking place in the vapor phase, and more preferably from about 127° C. to 452° C. For liquid phase reactions, the condensation temperature may be from about 7° C. to 477° C., and the condensation pressure from about 0.1 kPa to 10,000 kPa. Preferably, the condensation temperature is between about 17° C. and 302° C., or between about 17° C. and 252° C. for difficult substrates.

Varying the factors above, as well as others, will generally result in a modification to the specific composition and yields of the C4+ compounds. For example, varying the temperature and/or pressure of the reactor system, or the particular catalyst formulations, may result in the production of C4+ alcohols and/or ketones instead of C4+ hydrocarbons. The C4+ hydrocarbon product may also contain a variety of olefins, and alkanes of various sizes (typically branched alkanes). Depending upon the condensation catalyst used, the hydrocarbon product may also include aromatic and cyclic hydrocarbon compounds. The C4+ hydrocarbon product may also contain undesirably high levels of olefins, which may lead to coking or deposits in combustion engines, or other undesirable hydrocarbon products. In such event, the hydrocarbon molecules produced may be optionally hydrogenated to reduce the ketones to alcohols and hydrocarbons, while the alcohols and unsaturated hydrocarbon may be reduced to alkanes, thereby forming a more desirable hydrocarbon product having low levels of olefins, aromatics or alcohols.

The condensation reactions may be carried out in any reactor of suitable design, including continuous-flow, batch, semi-batch or multi-system reactors, without limitation as to design, size, geometry, flow rates, etc. The reactor system may also use a fluidized catalytic bed system, a swing bed system, fixed bed system, a moving bed system, or a combination of the above. In some embodiments, bi-phasic (e.g., liquid-liquid) and tri-phasic (e.g., liquid-liquid-solid) reactors may be used to carry out the condensation reactions.

In a continuous flow system, the reactor system can include an optional dehydrogenation bed adapted to produce dehydrogenated oxygenated intermediates, an optional dehydration bed adapted to produce dehydrated oxygenated intermediates, and a condensation bed to produce C4+ compounds from the oxygenated intermediates. The dehydrogenation bed is configured to receive the reactant stream and produce the desired oxygenated intermediates, which may have an increase in the amount of carbonyl-containing compounds. The de-hydration bed is configured to receive the reactant stream and produce the desired oxygenated intermediates. The condensation bed is configured to receive the oxygenated intermediates for contact with the condensation catalyst and production of the desired C4+ compounds. For systems with one or more finishing steps, an additional reaction bed for conducting the finishing process or processes may be included after the condensation bed.

In an embodiment, the optional dehydration reaction, the optional dehydrogenation reaction, the optional ketonization reaction, the optional ring opening reaction, and the condensation reaction catalyst beds may be positioned within the same reactor vessel or in separate reactor vessels in fluid communication with each other. Each reactor vessel preferably includes an outlet adapted to remove the product stream from the reactor vessel. For systems with one or more finishing steps, the finishing reaction bed or beds may be within the same reactor vessel along with the condensation bed or in a separate reactor vessel in fluid communication with the reactor vessel having the condensation bed.

In an embodiment, the reactor system also includes additional outlets to allow for the removal of portions of the reactant stream to further advance or direct the reaction to the desired reaction products, and to allow for the collection and recycling of reaction byproducts for use in other portions of the system. In an embodiment, the reactor system also includes additional inlets to allow for the introduction of supplemental materials to further advance or direct the reaction to the desired reaction products, and to allow for the recycling of reaction byproducts for use in other reactions.

In an embodiment, the reactor system also includes elements which allow for the separation of the reactant stream into different components which may find use in different reaction schemes or to simply promote the desired reactions. For instance, a separator unit, such as a phase separator, extractor, purifier or distillation column, may be installed prior to the condensation step to remove water from the reactant stream for purposes of advancing the condensation reaction to favor the production of higher hydrocarbons. In an embodiment, a separation unit is installed to remove specific intermediates to allow for the production of a desired product stream containing hydrocarbons within a particular carbon number range, or for use as end products or in other systems or processes.

The condensation reaction can produce a broad range of compounds with carbon numbers ranging from C4 to C30 or greater. Exemplary compounds include, but are not limited to, C4+ alkanes, C4+ alkenes, C5+ cycloalkanes, C5+ cycloalkenes, aryls, fused aryls, C4+ alcohols, C4+ ketones, and mixtures thereof. The C4+ alkanes and C4+ alkenes may range from 4 to 30 carbon atoms (C4-C30 alkanes and C4-C30 alkenes) and may be branched or straight chained alkanes or alkenes. The C4+ alkanes and C4+ alkenes may also include fractions of C7-C14, C12-C24 alkanes and alkenes, respectively, with the C7-C14 fraction directed to jet fuel blend, and the C12-C24 fraction directed to a diesel fuel blend and other industrial applications. Examples of various C4+ alkanes and C4+ alkenes include, without limitation, butane, butene, pentane, pentene, 2-methylbutane, hexane, hexene, 2-methylpentane, 3-methylpentane, 2,2-dimethylbutane, 2,3-dimethylbutane, heptane, heptene, octane, octene, 2,2,4,-trimethylpentane, 2,3-dimethyl hexane, 2,3,4-trimethylpentane, 2,3-dimethylpentane, nonane, nonene, decane, decene, undecane, undecene, dodecane, dodecene, tridecane, tridecene, tetradecane, tetradecene, pentadecane, pentadecene, hexadecane, hexadecene, heptyldecane, heptyldecene, octyldecane, octyldecene, nonyldecane, nonyldecene, eicosane, eicosene, uneicosane, uneicosene, doeicosane, doeicosene, trieicosane, trieicosene, tetraeicosane, tetraeicosene, and isomers thereof.

The C5+ cycloalkanes and C5+ cycloalkenes have from 5 to 30 carbon atoms and may be unsubstituted, mono-substituted or multi-substituted. In the case of mono-substituted and multi-substituted compounds, the substituted group may include a branched C3+ alkyl, a straight chain C1+ alkyl, a branched C3+ alkylene, a straight chain C1+ alkylene, a straight chain C2+ alkylene, a phenyl or a combination thereof. In one embodiment, at least one of the substituted groups include a branched C3-C12 alkyl, a straight chain C1-C12 alkyl, a branched C3-C12 alkylene, a straight chain C1-C12 alkylene, a straight chain C2-C12 alkylene, a phenyl or a combination thereof. In yet another embodiment, at least one of the substituted groups includes a branched C3-C4 alkyl, a straight chain C1-C4 alkyl, a branched C3-C4 alkylene, a straight chain C1-C4 alkylene, a straight chain C2-C4 alkylene, a phenyl, or any combination thereof. Examples of desirable C5+ cycloalkanes and C5+ cycloalkenes include, without limitation, cyclopentane, cyclopentene, cyclohexane, cyclohexene, methyl-cyclopentane, methyl-cyclopentene, ethyl-cyclopentane, ethyl-cyclopentene, ethyl-cyclohexane, ethyl-cyclohexene, and isomers thereof.

Aryls will generally consist of an aromatic hydrocarbon in either an unsubstituted (phenyl), mono-substituted or multi-substituted form. In the case of mono-substituted and multi-substituted compounds, the substituted group may include a branched C3+ alkyl, a straight chain C1+ alkyl, a branched C3+ alkylene, a straight chain C2+ alkylene, a phenyl or a combination thereof. In one embodiment, at least one of the substituted groups includes a branched C3-C12 alkyl, a straight chain C1-C12 alkyl, a branched C3-C12 alkylene, a straight chain C2-C12 alkylene, a phenyl, or any combination thereof. In yet another embodiment, at least one of the substituted groups includes a branched C3-C4 alkyl, a straight chain C1-C4 alkyl, a branched C3-C4 alkylene, straight chain C2-C4 alkylene, a phenyl, or any combination thereof. Examples of various aryls include, without limitation, benzene, toluene, xylene (dimethylbenzene), ethyl benzene, para xylene, meta xylene, ortho xylene, C9 aromatics.

Fused aryls will generally consist of bicyclic and polycyclic aromatic hydrocarbons, in either an unsubstituted, mono-substituted or multi-substituted form. In the case of mono-substituted and multi-substituted compounds, the substituted group may include a branched C3+ alkyl, a straight chain C1+ alkyl, a branched C3+ alkylene, a straight chain C2+ alkylene, a phenyl or a combination thereof. In another embodiment, at least one of the substituted groups includes a branched C3-C4 alkyl, a straight chain C1-C4 alkyl, a branched C3-C4 alkylene, a straight chain C2-C4 alkylene, a phenyl, or any combination thereof. Examples of various fused aryls include, without limitation, naphthalene, anthracene, tetrahydronaphthalene, and decahydronaphthalene, indane, indene, and isomers thereof.

The moderate fractions, such as C7-C14, may be separated for jet fuel, while heavier fractions, (e.g., C12-C24), may be separated for diesel use. The heaviest fractions may be used as lubricants or cracked to produce additional gasoline and/or diesel fractions. The C4+ compounds may also find use as industrial chemicals, whether as an intermediate or an end product. For example, the aryls toluene, xylene, ethyl benzene, para xylene, meta xylene, ortho xylene may find use as chemical intermediates for the production of plastics and other products. Meanwhile, the C9 aromatics and fused aryls, such as naphthalene, anthracene, tetrahydronaphthalene, and decahydronaphthalene, may find use as solvents in industrial processes.

In an embodiment, additional processes are used to treat the fuel blend to remove certain components or further conform the fuel blend to a diesel or jet fuel standard. Suitable techniques include hydrotreating to reduce the amount of or remove any remaining oxygen, sulfur, or nitrogen in the fuel blend. The conditions for hydrotreating a hydrocarbon stream are known to one of ordinary skill in the art.

In an embodiment, hydrogenation is carried out in place of or after the hydrotreating process to saturate at least some olefinic bonds. In some embodiments, a hydrogenation reaction may be carried out in concert with the aldol condensation reaction by including a metal functional group with the aldol condensation catalyst. Such hydrogenation may be performed to conform the fuel blend to a specific fuel standard (e.g., a diesel fuel standard or a jet fuel standard). The hydrogenation of the fuel blend stream can be carried out according to known procedures, either with the continuous or batch method. The hydrogenation reaction may be used to remove a remaining carbonyl group or hydroxyl group. In such event, any one of the hydrogenation catalysts described above may be used. Such catalysts may include any one or more of the following metals, Cu, Ni, Fe, Co, Ru, Pd, Rh, Pt, Ir, Os, alloys or combinations thereof, alone or with promoters such as Au, Ag, Cr, Zn, Mn, Sn, Cu, Bi, and alloys thereof, may be used in various loadings ranging from about 0.01 wt % to about 20 wt % on a support as described above. In general, the finishing step is carried out at finishing temperatures of between about 80° C. to 250° C., and finishing pressures in the range of about 700 kPa to 15,000 kPa. In one embodiment, the finishing step is conducted in the vapor phase or liquid phase, and uses, external H₂, recycled H₂, or combinations thereof, as necessary.

In an embodiment, isomerization is used to treat the fuel blend to introduce a desired degree of branching or other shape selectivity to at least some components in the fuel blend. It may be useful to remove any impurities before the hydrocarbons are contacted with the isomerization catalyst. The isomerization step comprises an optional stripping step, wherein the fuel blend from the oligomerization reaction may be purified by stripping with water vapor or a suitable gas such as light hydrocarbon, nitrogen or hydrogen. The optional stripping step is carried out in a counter-current manner in a unit upstream of the isomerization catalyst, wherein the gas and liquid are contacted with each other, or before the actual isomerization reactor in a separate stripping unit utilizing counter-current principle.

After the optional stripping step the fuel blend can be passed to a reactive isomerization unit comprising one or several catalyst bed(s). The catalyst beds of the isomerization step may operate either in co-current or counter-current manner. In the isomerization step, the pressure may vary from 2000 kPa to 15,000 kPa, preferably in the range of 2000 kPa to 10,000 kPa, the temperature being between 197° C. and 502° C., preferably between 302° C. and 402° C. In the isomerization step, any isomerization catalysts known in the art may be used. Suitable isomerization catalysts can contain molecular sieve and/or a metal from Group VII and/or a carrier. In an embodiment, the isomerization catalyst contains SAPO-11 or SAPO41 or ZSM-22 or ZSM-23 or ferrierite and Pt, Pd or Ni and Al₂O₃ or SiO₂. Typical isomerization catalysts are, for example, Pt/SAPO-11/Al₂O₃, Pt/ZSM-22/Al₂O₃, Pt/ZSM-23/Al₂O₃ and Pt/SAPO-11/SiO₂.

Other factors, such as the concentration of water or undesired oxygenated intermediates, may also effect the composition and yields of the C4+ compounds, as well as the activity and stability of the condensation catalyst. In such event, the process may include a dewatering step that removes a portion of the water prior to the condensation reaction and/or the optional dehydration reaction, or a separation unit for removal of the undesired oxygenated intermediates. For instance, a separator unit, such as a phase separator, extractor, purifier or distillation column, may be installed prior to the condensation step so as to remove a portion of the water from the reactant stream containing the oxygenated intermediates. A separation unit may also be installed to remove specific oxygenated intermediates to allow for the production of a desired product stream containing hydrocarbons within a particular carbon range, or for use as end products or in other systems or processes.

Thus, in one embodiment, the fuel blend produced by the processes described herein is a hydrocarbon mixture that meets the requirements for jet fuel (e.g., conforms with ASTM D1655). In another embodiment, the product of the processes described herein is a hydrocarbon mixture that comprises a fuel blend meeting the requirements for a diesel fuel (e.g., conforms with ASTM D975).

Yet in another embodiment of the invention, the C₂₊ olefins are produced by catalytically reacting the oxygenated intermediates in the presence of a dehydration catalyst at a dehydration temperature and dehydration pressure to produce a reaction stream comprising the C₂₊ olefins. The C₂₊ olefins comprise straight or branched hydrocarbons containing one or more carbon-carbon double bonds. In general, the C₂₊ olefins contain from 2 to 8 carbon atoms, and more preferably from 3 to 5 carbon atoms. In one embodiment, the olefins comprise propylene, butylene, pentylene, isomers of the foregoing, and mixtures of any two or more of the foregoing. In another embodiment, the C₂₊ olefins include C₄₊ olefins produced by catalytically reacting a portion of the C₂₊ olefins over an olefin isomerization catalyst. In an embodiment, a method of forming a fuel blend from a biomass feedstock may comprise a digester that receives a biomass feedstock and a digestive solvent operating under conditions to effectively remove nitrogen and sulfur compounds from said biomass feedstock and discharges a treated stream comprising a carbohydrate having less than 35% of the sulfur content and less than 35% of the nitrogen content based on the untreated biomass feedstock on a dry mass basis; a hydrogenolysis reactor comprising a hydrogenolysis catalyst that receives the treated stream and discharges an oxygenated intermediate, wherein a first portion of the oxygenated intermediate stream is recycled to the digester as at least a portion of the digestive solvent; a first fuels processing reactor comprising a dehydrogenation catalyst that receives a second portion of the oxygenated intermediate stream and discharges an olefin-containing stream; and a second fuels processing reactor comprising an alkylation catalyst that receives the olefin-containing stream and discharges a liquid fuel.

The dehydration catalyst comprises a member selected from the group consisting of an acidic alumina, aluminum phosphate, silica-alumina phosphate, amorphous silica-alumina, aluminosilicate, zirconia, sulfated zirconia, tungstated zirconia, tungsten carbide, molybdenum carbide, titania, sulfated carbon, phosphated carbon, phosphated silica, phosphated alumina, acidic resin, heteropolyacid, inorganic acid, and a combination of any two or more of the foregoing. In one embodiment, the dehydration catalyst further comprises a modifier selected from the group consisting of Ce, Y, Sc, La, Li, Na, K, Rb, Cs, Mg, Ca, Sr, Ba, P, B, Bi, and a combination of any two or more of the foregoing. In another embodiment, the dehydration catalyst further comprises an oxide of an element, the element selected from the group consisting of Ti, Zr, V, Nb, Ta, Mo, Cr, W, Mn, Re, Al, Ga, In, Fe, Co, Ir, Ni, Si, Cu, Zn, Sn, Cd, P, and a combination of any two or more of the foregoing. In yet another embodiment, the dehydration catalyst further comprises a metal selected from the group consisting of Cu, Ag, Au, Pt, Ni, Fe, Co, Ru, Zn, Cd, Ga, In, Rh, Pd, Ir, Re, Mn, Cr, Mo, W, Sn, Os, an alloy of any two or more of the foregoing, and a combination of any two or more of the foregoing.

In yet another embodiment, the dehydration catalyst comprises an aluminosilicate zeolite. In one version, the dehydration catalyst further comprises a modifier selected from the group consisting of Ga, In, Zn, Fe, Mo, Ag, Au, Ni, P, Sc, Y, Ta, a lanthanide, and a combination of any two or more of the foregoing. In another version, the dehydration catalyst further comprises a metal selected from the group consisting of Cu, Ag, Au, Pt, Ni, Fe, Co, Ru, Zn, Cd, Ga, In, Rh, Pd, Ir, Re, Mn, Cr, Mo, W, Sn, Os, an alloy of any two or more of the foregoing, and a combination of any two or more of the foregoing.

In another embodiment, the dehydration catalyst comprises a bifunctional pentasil ring-containing aluminosilicate zeolite. In one version, the dehydration catalyst further comprises a modifier selected from the group consisting of Ga, In, Zn, Fe, Mo, Ag, Au, Ni, P, Sc, Y, Ta, a lanthanide, and a combination of any two or more of the foregoing. In another version, the dehydration catalyst further comprises a metal selected from the group consisting of Cu, Ag, Au, Pt, Ni, Fe, Co, Ru, Zn, Cd, Ga, In, Rh, Pd, Ir, Re, Mn, Cr, Mo, W, Sn, Os, an alloy of any two or more of the foregoing, and a combination of any two or more of the foregoing.

The dehydration reaction is conducted at a temperature and pressure where the thermodynamics are favorable. In general, the reaction may be performed in the vapor phase, liquid phase, or a combination of both. In one embodiment, the dehydration temperature is in the range of about 100° C. to 500° C., and the dehydration pressure is in the range of about 0 psig to 900 psig. In another embodiment, the dehydration temperature is in the range of about 125° C. to 450° C., and the dehydration pressure is at least 2 psig. In another version, the dehydration temperature is in the range of about 150° C. to 350° C., and the dehydration pressure is in the range of about 100 psig to 800 psig. In yet another version, the dehydration temperature is in the range of about 175° C. to 325° C.

The C₆₊ paraffins are produced by catalytically reacting the C₂₊ olefins with a stream of C₄₊ isoparaffins in the presence of an alkylation catalyst at an alkylation temperature and alkylation pressure to produce a product stream comprising C₆₊ paraffins. The C₄₊ isoparaffins include alkanes and cycloalkanes having 4 to 7 carbon atoms, such as isobutane, isopentane, naphthenes, and higher homologues having a tertiary carbon atom (e.g., 2-methylbutane and 2,4-dimethylpentane), isomers of the foregoing, and mixtures of any two or more of the foregoing. In one embodiment, the stream of C₄₊ isoparaffins comprises of internally generated C₄₊ isoparaffins, external C₄₊ isoparaffins, recycled C₄₊ isoparaffins, or combinations of any two or more of the foregoing.

The C₆₊ paraffins will generally be branched paraffins, but may also include normal paraffins. In one version, the C₆₊ paraffins comprises a member selected from the group consisting of a branched C₆₋₁₀ alkane, a branched C₆ alkane, a branched C₇ alkane, a branched C₈ alkane, a branched C₉ alkane, a branched C₁₀ alkane, or a mixture of any two or more of the foregoing. In one version, the C.sub.6+ paraffins comprise dimethylbutane, 2,2-dimethylbutane, 2,3-dimethylbutane, methylpentane, 2-methylpentane, 3-methylpentane, dimethylpentane, 2,3-dimethylpentane, 2,4-dimethylpentane, methylhexane, 2,3-dimethylhexane, 2,3,4-trimethylpentane, 2,2,4-trimethylpentane, 2,2,3-trimethylpentane, 2,3,3-trimethylpentane, dimethylhexane, or mixtures of any two or more of the foregoing.

The alkylation catalyst comprises a member selected from the group of sulfuric acid, hydrofluoric acid, aluminum chloride, boron trifluoride, solid phosphoric acid, chlorided alumina, acidic alumina, aluminum phosphate, silica-alumina phosphate, amorphous silica-alumina, aluminosilicate, aluminosilicate zeolite, zirconia, sulfated zirconia, tungstated zirconia, tungsten carbide, molybdenum carbide, titania, sulfated carbon, phosphated carbon, phosphated silica, phosphated alumina, acidic resin, heteropolyacid, inorganic acid, and a combination of any two or more of the foregoing. The alkylation catalyst may also include a mixture of a mineral acid with a Friedel-Crafts metal halide, such as aluminum bromide, and other proton donors.

In one embodiment, the alkylation catalyst comprises an aluminosilicate zeolite. In one version, the alkylation catalyst further comprises a modifier selected from the group consisting of Ga, In, Zn, Fe, Mo, Ag, Au, Ni, P, Sc, Y, Ta, a lanthanide, and a combination of any two or more of the foregoing. In another version, the alkylation catalyst further comprises a metal selected from the group consisting of Cu, Ag, Au, Pt, Ni, Fe, Co, Ru, Zn, Cd, Ga, In, Rh, Pd, Ir, Re, Mn, Cr, Mo, W, Sn, Os, an alloy of any two or more of the foregoing, and a combination of any two or more of the foregoing.

In another embodiment, the alkylation catalyst comprises a bifunctional pentasil ring-containing aluminosilicate zeolite. In one version, the alkylation catalyst further comprises a modifier selected from the group consisting of Ga, In, Zn, Fe, Mo, Ag, Au, Ni, P, Sc, Y, Ta, a lanthanide, and a combination of any two or more of the foregoing. In another version, the alkylation catalyst further comprises a metal selected from the group consisting of Cu, Ag, Au, Pt, Ni, Fe, Co, Ru, Zn, Cd, Ga, In, Rh, Pd, Ir, Re, Mn, Cr, Mo, W, Sn, Os, an alloy of any two or more of the foregoing, and a combination of any two or more of the foregoing. In one version, the dehydration catalyst and the alkylation catalyst are atomically identical.

The alkylation reaction is conducted at a temperature where the thermodynamics are favorable. In general, the alkylation temperature is in the range of about −20° C. to 300° C., and the alkylation pressure is in the range of about 0 psig to 1200 psig. In one version, the alkylation temperature is in the range of about 100° C. to 300° C. In another version, the alkylation temperature is in the range of about 0° C. to 100° C., and the alkylation pressure is at least 100 psig. In yet another version, the alkylation temperature is in the range of about 0° C. to 50° C. and the alkylation pressure is less than 300 psig. In still yet another version, the alkylation temperature is in the range of about 70° C. to 250° C., and the alkylation pressure is in the range of about 100 psig to 1200 psig. In one embodiment, the alkylation catalyst comprises a mineral acid or a strong acid and the alkylation temperature is less than ° C. In another embodiment, the alkylation catalyst comprises a zeolite and the alkylation temperature is greater than 100° C.

In an embodiment of the present invention, the fuel yield of the current process may be greater than other bio-based feedstock conversion processes. Without wishing to be limited by theory, it is believed that substantially removing nitrogen compounds and sulfur compounds from the biomass prior to the direct hydrogenolysis allows for a greater percentage of the biomass to be converted into higher hydrocarbons while limiting the formation of degradation products.

To facilitate a better understanding of the present invention, the following examples of certain aspects of some embodiments are given. In no way should the following examples be read to limit, or define, the entire scope of the invention.

### EXAMPLES

Reaction studies were conducted in a Parr5000 Hastelloy multireactor comprising 6×75-milliliter reactors operated in parallel at pressures up to 135 bar, and temperatures up to 275° C., stirred by magnetic stir bar. Alternate studies were conducted in 100-ml Parr 4750 reactors, with mixing by top-driven stir shaft impeller, also capable of 135 bar and 275° C. Larger scale extraction, pretreatment and digestion tests were conducted in a 1-Liter Parr reactor with annular basket housing biomass feed, or with filtered dip tube for direct contacting of biomass slurries.

Reaction samples were analyzed for sugar, polyol, and organic acids using an HPLC method entailing a Bio-Rad Aminex HPX-87H column (300 mm×7.8 mm) operated at 0.6 ml/minute of a mobile phase of 5 mM Sulfuric Acid in water, at an oven temperature of 30° C., a run time of 70 minutes, and both R1 and UV (320 nm) detectors.

Product formation (mono-oxygenates, glycols, diols, alkanes, acids) were monitored via a gas chromatographic (GC) method “DB5-ox”, entailing a60-m×0.32 mm ID DB-5 column of 1 um thickness, with 50:1 split ratio, 2 ml/min helium flow, and column oven at 40° C. for 8 minutes, followed by ramp to 285° C. at 10° C./min, and a hold time of 53.5 minutes. Injector temperature is set at 250° C., and detector temperature at 300° C.

Gasoline production potential by condensation was assessed via injection of one microliters of liquid intermediate product into a catalytic pulse microreactor entailing a GC insert packed with 0.12 grams of ZSM-5 catalyst, held at 375° C., followed by Restek Rtx-1701 (60-m) and DB-5 (60-m) capillary GC columns in series (120-m total length, 0.32 mm ID, 0.25 um film thickness) for an Agilent/HP 6890 GC equipped with flame ionization detector. Helium flow was 2.0 ml/min (constant flow mode), with a 10:1 split ratio. Oven temperature was held at 35° C. for 10 minutes, followed by a ramp to 270° C. at 3° C./min, followed by a 1.67 minute hold time. Detector temperature was 300° C.

### Examples 1-6

### Poisoning of Platinum Catalysts

A set of experiments were conducted in the Parr5000 multi-reactor filled with 20-grams of 50% glycerol in deionized water a supported platinum catalyst (0.35-grams of 5% Pt/alumina (Escat™ 2941 from Strem Chemicals, Inc., or 0.15 grams of a 1.9% Pt/zirconia modified with rhenium at Re:Pt rato of 3.75:1 prepared by the method according to US2008/0215391, Example 7. Varying amounts of N,S-amino acid cysteine, or N-amino acid alanine, were added to assess impact on rates. Reactors were pressured to 500 psig of H₂, with heating to 255° C. for 6.5 hours. Unconverted glycerol was determined by HPLC analysis, and by GC analysis using the DB5-ox method, while reaction products from showed convertion to propylene glycol, isopropanol, and n-propanol intermediates.

A first order reaction rate was calculated relative to the weight fraction of catalyst in liquid solution (Table 1). Results indicated strong sensitivity to both N and N,S amino acids for the 5% Pt/alumina catalyst. The Re-modified platinum catalyst was also strongly poisoned by N,S amino acid cysteine, but to a lesser extent by N-amino acid alanine. Where strong poisoning was indicated, activity was reduce to less than ⅓ of unpoisoned catalyst activity.

TABLE 1
Pt catalyst poisoning via amino acids

| | | | g-amino | | |
|---|---|---|---|---|---|
| | | amino | acid/ | rate | Relative |
| | Catalyst | acid | g-catalyst | (1/h/wt) | rate |
| Ex 1 | 5% Pt/Al₂O₃ | none | 8.6% | 10.3 | 1.00 |
| Ex 2 | 5% Pt/Al₂O₃ | cysteine | 8.6% | 3.0 | 0.29 |
| Ex 3 | 5% Pt/Al₂O₃ | alanine | 8.6% | 3.6 | 0.35 |
| Ex 4 | 1.9% Pt (3.75 Re:Pt)/ | none | 20.0% | 35.9 | 1.00 |
| | ZrO₂ | | | | |
| Ex 5 | 1.9% Pt (3.75 Re:Pt)/ | cysteine | 20.0% | 5.2 | 0.14 |
| | ZrO₂ | | | | |
| Ex 6 | 1.9% Pt (3.75 Re:Pt)/ | alanine | 20.0% | 28.7 | 0.80 |
| | ZrO₂ | | | | |

### Examples 7-9

### Ru/Silica Poisoining

The experiment of Examples 1-6 were repeated at 240° C. with 5% Ru/silica catalyst (x-Engelhard Corp., Inc.) and a feed solution of 33.7 wt % glycerol. Fresh catalyst gave a rate of glycerol conversion of 1.85 l/h/wt-catalyst (Example 7). Addition of 7.5% by weight of N,S amino acid cysteine relative to catalyst, gave an activity that was only 8.5% of fresh, unpoisoned catalyst activity (Example 8). Addition of only 1.3% cysteine relative to catalyst resulted in a glycerol conversion rate that was 11.5% of fresh, unpoisoned catalyst (Example 9). These results indicated strong poisoning of glycerol or sugar alcohol hydrogenolysis or hydro-deoxygenation, by small amounts of N,S-containing amino acid.

### Examples 10-12

### NaHS and Cysteine Poisoning Ru/C Sorbitol

The experiments of Examples 7-9 were repeated with 0.4 grams of 5% Ru/C catalyst (Escat™ 4401 from Strem Chemicals, Inc.) and a reaction temperature of 245° C., with a feed of 50% sorbitol in deionized water. Fresh, unpoisonied catalyst exhibited a first-order rate of 42 l/h/wt-catalyst for sorbitol conversion (Example 10). NaHS was added at 9.1% of catalyst weight, giving activity for sorbitol conversion of only 11% of that of fresh catalyst (Example 11). N,S-amino acid Cysteine was added at 6.7% of catalyst weight, resulting in an activity for sorbitol conversion of only 5.7% of that of fresh, unpoisoned catalyst (Example 12). This example shows poisoning by NaHS and by cysteine, for hydrogenolysis or hydrodeoxygenation reactions catalyzed by Ru/C.

### Examples 13-16

### Poisoning of Nickel Catalyst by Cysteine

The experiment of Examples 10-12 was repeated with 65% Nickel/silica-alumina catalyst (from Sigma-Aldrich, Inc.). Fresh unpoisoned catalyst gave a rate of 68 l/h/wt-catalyst (Example 13). Addition of 8.7% cysteine led to loss of 92% of activity (Example 14). A second catalyst formulation of 58% nickel on silica/kieselguhr (x-Engelhard Corp., Inc.) exhibited a first order rate for sorbitol conversion of 19.9 l/h/wt-catalyst (Example 15). Addition of only 1.9% cysteine resulted in a loss of 91% of measured activity (Example 16).

### Examples 17-18

### Poison Tolerant Cobalt-Molybdate Catalyst

The conditions of experiments 1-6 were conducted with 0.35 grams of nickel-oxide promoted cobalt molybdate catalyst, DC-2533 (containing 1-10% cobalt oxide and molybdenum trioxide (up to 30 wt %) and phosphorus oxide (up to 9%) on alumina, and less than 2% nickel) from Criterion Catalyst & Technologies L.P, and 20 grams of 50% glycerol in deionized water. The catalyst was sulfided by the method described in US2010/0236988 Example 5. After addition of 500 psig hydrogen, reactors were heated to 255° C. for 6.5 hours.

First order rate observed for the sulfided catalyst (Example 17) was 9.4 l/h/wt-catalyst, relative to a rate of 7.8 l/h/wt-catalyst for addition of 8.4% cysteine relative to catalyst in Example 18. Suppression of activity upon addition of cysteine was considered low or negligible, relative to experimental variability. This experiment demonstrates the tolerance of the sulfided cobalt molybdate catalyst to N,S-amino acid.

### Example 19

### Sulfided Cobalt Molybdate Catalyst

A multi-cycle experiment was conducted using a nominal 3.50 grams of bagasse with 1.04 grams of sulfided cobalt-molybdate catalyst (DC-2533 for Criterion Catalyst & Technologies L.P.), and 58.50 grams of deionized water. The catalyst was sulfided by the method described in US2010/0236988, Example 5. The Parr 100-ml reactor was pressured to 1024 psig with H₂ (7200 kPa), and heated to 170° C., and ramped to 240° C. over 7 hours, before holding at 240° C. overnight to completed an initial cycle. Four additional cycles were completed in subsequent 24-hour periods, entailing 9-hour ramps from 160-250° C., before holding at 250° C. overnight. A total of 17.59 grams of bagasse were charged for the five cycles.

A final pH of 3.49 was measured, indicated acid formation from the biomass feed. DB5-ox GC analysis indicated 1.67% acetic acid present in the final reaction liquid. Following reaction, solids were recovered by filtration on Whatman #2 filter paper, and oven dried overnight at 90° C. to assess the extent of digestion of biomoass. Results indicaed 73% of the total bagasse charged over was digested into liquid soluble products. Ethylene glycol (10.8%) and 1,2-propylene glycol (14.9%) comprised more than 25.7% of the hydrocarbon products, as measured via DB5-ox GC method (Table 2). The remainder of product analyzed as a mixture of primarily C2-C6 oxygenates (alcohols, ketones), and carboxylic acids, suitable for condensation to liquid biofuels.

Liquid product was injected onto the ZSM-5 pulse microreactor at 375° C. to assess gasoline formation potential. Formation of alkanes, benzene, toluene, xylenes, trimethlybenzenes, and naphthalenes were observed at an approximate yield of 36% relative to that expected from complete conversion of the carbohydrate fraction of the feed bagasse. This result demonstrates co-production of glycols and liquid biofuels via direct hydrogenolysis of biomass over sulfided cobalt-molybdate catalyst, followed by acid-catalyzed condensation of oxygenates present in the hydrogenolysis product stream.

TABLE 2
Bagasse Hydrogenolysis with Sulfided Cobalt-Molybdate catalyst

| | wt % of Total |
|---|---|
| Component | HC products |
| Ethylene glycol | 10.8 |
| 1,2-Propylene | 14.9 |
| glycol | |
| Glycerol | 6.6 |
| Erythritol | 11.7 |
| Total polyols | 44.0 |
| Total glycols | 25.7 |

### Example 20

### Use of Calcium Carbonate Cocatalyst/Buffer

Example 19 was repeated with addition of 2.06 grams of calcium carbonate for the initial reaction, followed by addition of 0.50-0.51 grams of calcium carbonate for each successive cycle, to maintain a pH of greater than 4.5 throughout the reaction sequence. A final pH of 4.84 was measured at the end of the fifth cycle. A total of 18.71 grams of bagasse (dry basis) were charged across the five reaction cycles.

Following reaction, solids were recovered by filtration on Whatman #2 filter paper, and oven dried overnight at 90° C. to assess the extent of digestion of biomoass. Results indicated 90% of the total bagasse charged over was digested into liquid soluble products. Ethylene glycol (9.1%) and 1,2-propylene glycol (32.8%) comprised more than 41% of the hydrocarbon products, as measured via DB5-ox GC method (Table 3). The remainder of product analyzed as a mixture of primarily C2-C6 oxygenates (alcohols, ketones), and carboxylic acids, suitable for condensation to liquid biofuels.

Liquid product was injected onto the ZSM-5 pulse microreactor at 375° C. to assess gasoline formation potential. Formation of alkanes, benzene, toluene, xylenes, trimethlybenzenes, and naphthalenes were observed at an approximate yield of 50% relative to that expected from complete conversion of the carbohydrate fraction of the feed bagasse. This result demonstrates co-production of glycols and liquid biofuels via direct hydrogenolysis of biomass over sulfided cobalt-molybdate catalyst, followed by acid-catalyzed condensation of oxygenates present in the hydrogenolysis product stream. Use of a basic buffer such as calcium carbonate to improve yields of glycols, and moderate pH, is also established.

TABLE 3
Hydrogenolysis with sulfided cobalt molybdate
catalyst and calcium carbonate buffer

| | wt % of total |
|---|---|
| Component | HC products |
| Ethylene glycol | 9.1 |
| 1,2-Propylene | 32.8 |
| glycol | |
| Glycerol | 1.0 |
| Erythritol | 0.2 |
| Total polyols | 43.0 |
| Total glycols | 41.9 |

### Example 21

### Sulfided Cobalt Molybdate Catalyst with KOH Buffer

Experiment 20 was repeated with addition of 1N KOH to buffer pH to 5.5 for each reaction step. Three reaction cycles were conducted with addition of 10.03 grams of bagasse (dry basis). A final pH of 5.34 was measured for the liquid product of three cycles.

Following reaction, solids were recovered by filtration on Whatman #2 filter paper, and oven dried overnight at 90° C. to assess the extent of digestion of biomoass. Results indicated 87.9% of the total bagasse charged over was digested into liquid soluble products. Ethylene glycol (5.1%) and 1,2-propylene glycol (16.7%) comprised more than 21% of the hydrocarbon products, as measured via DB5-ox GC method (Table 4). Further conversion of glycerol (8.2%) to propylene glycol can be achieved via continuing the —OH hydrogenolysis reaction, resulting in higher yields of glycol products. The remainder of product analyzed as a mixture of primarily C2-C6 oxygenates (alcohols, ketones) and carboxylic acids, suitable for condensation to liquid biofuels.

Liquid product was injected onto the ZSM-5 pulse microreactor at 375° C. to assess gasoline formation potential. Formation of alkanes, benzene, toluene, xylenes, trimethlybenzenes, and naphthalenes were observed at an approximate yield of 69% relative to that expected from complete conversion of the carbohydrate fraction of the feed bagasse. This result demonstrates co-production of glycols and liquid biofuels via direct hydrogenolysis of biomass over sulfided cobalt-molybdate catalyst, followed by acid-catalyzed condensation of oxygenates present in the hydrogenolysis product stream. Use of potassium hydroxide as a basic buffer to maintain pH>5 was demonstrated to give high yields of glycol intermediate products.

TABLE 4
Bagasse Hydrogenolysis with Sulfided Cobalt
Molybdate catalyst and KOH buffer

| | wt % of |
|---|---|
| Component | HC products |
| Ethylene glycol | 5.1 |
| 1,2-Propylene | 16.7 |
| glycol | |
| Glycerol | 8.2 |
| Erythritol | 12.0 |
| Total polyols | 42.0 |
| Total glycols | 21.8 |

### Example 21

### Sulfided vs. Unsulfided DC2534 Catalyst

A series of experiments were conducted with nickel-oxide promoted cobalt molybdate catalyst, DC-2534 (containing 1-10% cobalt oxide and molybdenum trioxide (up to 30 wt %) and phosphorus oxide (up to 9%) on alumina, and less than 2% nickel) from Criterion Catalyst & Technologies L.P, using lower loadings of Co and Mo than DC2533. For examples 21, 22, and 23, the catalyst was reduced under flowing hydrogen at a space velocity of 10 volumes of gas per volume of catalyst per minute, with a temperature ramp from 25° C. to 400° C. at 12.5° C. per hour, followed by a 2-hour hold at final temperature. For examples 24 and 25, the catalyst was sulfided by the method described in US2010/0236988 Example 5. For example 26, the untreated, synthesized catlayst was used directly.

For each example 21-26, 0.3 grams of catalyst prepared as described above, were charged to a Parr 5000 reactor along with 25 grams of a solution of 50% 2-propanol, 6% glycerol in deionized water. 2500 ppm sodium carbonate was added to buffer pH to greater than 5. The batch reactors were pressured to 50 bar with hydrogen, and heated to 240° C. for 5 hours, before sampling for HPLC analysis of glycerol, and hydrogenolysis and hydrodeoxygenation products propylene glycol and glycerol.

Results of the batch reaction tests are presented in Table 5. Only slight conversion of glycerol was observed for the H₂-reduced but unsulfided catalyst in Example 22. Addition of 1200 ppm of N,S amino acid cysteine also gave neglibible conversion for Example 23, as did addition of 2400 ppm of N-only amino acid alanine for example 23.

For Example 25, sulfided catalyst gave 93% conversion of glycerol to primarily propylene glycol and ethylene glycol products, in the absence of added poisons. Conversion in the presence of 1200 ppm cysteine was 83% for Example 24. Example 26 exhibited a glycerol conversion of less than 1%, using untreated catalyst in the presence of 2400 ppm alanine and 1200 ppm cysteine.

These examples demonstrate that sulfiding, not reduction by H₂, is required for catalytic activity in hydrodeoxygenation and hydrogenolysis of glycerol to form 1,2-propylene glycol, and ethylene glycol. Presense of 1200 ppm of N,S amino acid cysteine is not sufficient to establish significant activity, for reduced or untreated cobalt molybdate catalyst. Activity for sulfided catalyst in the presence of cysteine poison, is nearly as strong as that observed with unpoisoned feed.

TABLE 5
Reduction vs. Sulfiding of Cobalt Molybdate Catalyst
Conversion of glycerol for 5-h at 240° C. with 50 bar H₂, 1.2 wt % catalyst

| Ex# | Pretreatment | Poison | Pois (ppm) | Conversion |
|---|---|---|---|---|
| 21 | H2 to 400° C. | cysteine | 1200 | 1.29% |
| 22 | H2 to 400° C. | none | 0 | 1.08% |
| 23 | H2 to 400° C. | alanine | 2400 | 0.00% |
| 24 | Sulfide | cysteine | 1200 | 82.94% |
| 25 | Sulfide | none | 0 | 92.75% |
| 26 | None | cys/ala | 1200/2400 | 0.33% |

What is claimed is:

1. A method comprising: (i) providing a biomass containing celluloses, hemicelluloses, lignin, nitrogen, and sulfur compounds; (ii) contacting the biomass with a digestive solvent to form a pretreated biomass containing soluble carbohydrates; (iii) contacting the pretreated biomass with hydrogen at a temperature in the range of 180° C. to 290° C. in the presence of a supported hydrogenolysis catalyst containing (a) sulfur, (b) Mo or W, and (c) Co, Ni or mixture thereof, incorporated into a suitable support, to form a plurality of oxygenated intermediates, and (vi) processing at least a portion of the oxygenated intermediates to form a liquid fuel.

2. The method of claim 1 wherein a first portion of the oxygenated intermediates are recycled to form in part the solvent in step (ii); and processing at least a second portion of the oxygenated intermediates to form a liquid fuel.

3. The method of claim 1 wherein the supported hydrogenolysis catalyst is supported on an alumina.

4. The method of claim 1 wherein the supported hydrogenolysis catalyst is a sulfided CoNiMo catalyst.

5. The method of claim 4 wherein the catalyst is supported on an alumina.

6. The method of claim 1 wherein sulfur content of the catalyst is in the range of 0.1 wt % to 40 wt % based on components (b) and (c) as metal oxide form.

7. The method of claim 6 wherein the molybdenum content of the catalyst is in the range of about 2 wt. % to about 50 wt. % based on components (b) and (c) as metal oxide form.

8. The method of claim 6 wherein the Co and/or Ni content of the catalyst is in the range of about 0.5 wt. % to about 20 wt. % based on components (b) and (c) as metal oxide form.

9. The method of claim 7 wherein the Co and/or Ni content of the catalyst is in the range of about 0.5 wt. % to about 20 wt. % based on the components (b) and (c) as metal oxide form.

10. The method of claim 1 wherein the oxygenated intermediates is subjected to condensation to produce a liquid fuel.

11. The method of claim 4 wherein the oxygenated intermediates is subjected to condensation to produce a liquid fuel.

12. The method of claim 6 wherein the oxygenated intermediates is subjected to condensation to produce a liquid fuel.

13. The method of claim 7 wherein the oxygenated intermediates is subjected to condensation to produce a liquid fuel.

14. The method of claim 8 wherein the oxygenated intermediates is subjected to condensation to produce a liquid fuel.

15. The method of claim 2 wherein the oxygenated intermediates is subjected to condensation to produce a liquid fuel.

16. The method of claim 1 wherein the oxygenated intermediates is subjected to dehydration and alkylation to produce a liquid fuel.

17. The method of claim 4 wherein the oxygenated intermediates is subjected to dehydration and alkylation to produce a liquid fuel.

18. The method of claim 6 wherein the oxygenated intermediates is subjected to dehydration and alkylation to produce a liquid fuel.

19. The method of claim 7 wherein the oxygenated intermediates is subjected to dehydration and alkylation to produce a liquid fuel.

20. The method of claim 8 wherein the oxygenated intermediates is subjected to dehydration and alkylation to produce a liquid fuel

21. The method of claim 2 wherein the oxygenated intermediates is subjected to dehydration and alkylation to produce a liquid fuel.

22. The method of claim 1 wherein the supported hydrogenolysis catalyst further comprises Phosphorus.

23. The method of claim 1 wherein substantial portion of lignin is removed with the digestive solvent after step (ii).

24. A system comprising: a digester that receives a biomass feedstock and a digestive solvent operating under conditions effective to produce soluble carbohydrates from said biomass feedstock and discharges a treated stream comprising a soluble carbohydrate; a hydrogenolysis reactor comprising a supported hydrogenolysis catalyst containing (a) sulfur, (b) Mo or W, and (c) Co and/or Ni, that receives hydrogen and the treated stream and discharges an oxygenated intermediate stream, wherein a first portion of the oxygenated intermediate stream is recycled to the digester as at least a portion of the digestive solvent; and a fuels processing reactor comprising a condensation catalyst that receives a second portion of the oxygenated intermediate stream and discharges a liquid fuel.

25. A system comprising: a digester that receives a biomass feedstock and a digestive solvent operating under conditions effective to produce soluble carbohydrate from said biomass feedstock and discharges a treated stream comprising a soluble carbohydrate; a hydrogenolysis reactor comprising a supported hydrogenolysis catalyst containing (a) sulfur, (b) Mo or W, and (c) Co and/or Ni, that receives hydrogen and the treated stream and discharges an oxygenated intermediate, wherein a first portion of the oxygenated intermediate stream is recycled to the digester as at least a portion of the digestive solvent; a first fuels processing reactor comprising a dehydrogenation catalyst that receives a second portion of the oxygenated intermediate stream and discharges an olefin-containing stream; and a second fuels processing reactor comprising an alkylation catalyst that receives the olefin-containing stream and discharges a liquid fuel.

26. A composition comprising:
(i) lignocellulosic biomass;
(ii) hydrogenolysis catalyst containing (a) sulfur, (b) Mo or W, and (c) Co, Ni or mixture thereof, and (d) phosphorus, incorporated into a suitable support;
(iii) water; and
(iv) digestive solvent.
